(19) United States
(12) Patent Application Publication
(10) Pub. No.: US 2024/0186903 A1
(43) Pub. Date: Jun. 6, 2024

(54) POWER CONVERTER CONTROLLER WITH BIAS DRIVE CIRCUIT FOR BIAS SUPPLY

(71) Applicant: Power Integrations, Inc., San Jose, CA (US)

(72) Inventor: David Michael Hugh MATTHEWS, Los Gatos, CA (US)

(73) Assignee: Power Integrations, Inc., San Jose, CA (US)

(21) Appl. No.: 18/061,191

(22) Filed: Dec. 2, 2022

(51) Int. Cl. H02M 3/335; H02M 1/00; H02M 1/08

(52) U.S. Cl. CPC H02M 3/33507; H02M 1/0009; H02M 1/08

(57) ABSTRACT

A power converter controller with a bias drive circuit for bias supply is provided herein. The controller includes a primary drive circuit configured to control operation of a primary switch coupled to a primary winding associated with the energy transfer element. The primary drive circuit can cause the primary switch to transition between a conducting state during a first portion of a switching cycle and a nonconducting state during a second portion of the switching cycle. The controller also includes a bias drive circuit configured to control operation of a bias switch coupled to an auxiliary winding associated with the energy transfer element to drive a bias current to a bypass capacitor coupled to the bias drive circuit for providing a bias supply to the controller.

### BACKGROUND

### Field of the Disclosure

The present disclosure relates generally to power converters, and more specifically to controllers for power converters.

### Discussion of the Related Art

Electronic devices use power to operate. Switched mode power converters are commonly used due to their high efficiency, small size and low weight to power many of today's electronics. Conventional wall sockets provide a high voltage alternating current. In a switching power converter, a high voltage alternating current (ac) input is converted to provide a well-regulated direct current (dc) output through an energy transfer element. The switched mode power converter controller usually provides output regulation by sensing one or more signals representative of one or more output quantities and controlling the output in a closed loop. In operation, a switch is utilized to provide the desired output by varying the duty cycle (typically the ratio of the on time of the switch to the total switching period), varying the switching frequency, or varying the number of pulses per unit time of the switch in a switched mode power converter.

Power converters generally include one or more controllers that sense and regulate the output of the power converter. These controllers generally require a regulated or unregulated voltage source to power the circuit components of the controller. A capacitor, sometimes referred to as a bypass capacitor, is coupled to a controller to provide bias supply to the circuits of the controller, such that the circuits may have the appropriate voltage and/or current to operate.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1A is a schematic diagram of an example of an isolated power converter including a controller with a bias drive circuit to control a bias switch, in accordance with embodiments of the present disclosure.

FIG. 1B is a schematic diagram of another example of an isolated power converter including another example of a controller with a bias drive circuit to control a bias switch, in accordance with embodiments of the present disclosure.

FIG. 2A is a schematic illustrating an example of a bias drive circuit, in accordance with embodiments of the present disclosure.

FIG. 2B is a schematic illustrating an additional example of a bias drive circuit, in accordance with embodiments of the present disclosure.

FIG. 3 is a schematic illustrating another example of a bias drive circuit, in accordance with embodiments of the present disclosure.

FIG. 4 is a schematic illustrating a further example of a bias drive circuit, in accordance with embodiments of the present disclosure.

FIG. 5 is a schematic illustrating yet another example of a bias drive circuit, in accordance with embodiments of the present disclosure.

FIG. 6 is a timing diagram illustrating example waveforms of the power converter with controller and bias drive circuit of FIGS. 1A or 1B, in accordance with embodiments of the present disclosure.

FIG. 7 is a is a timing diagram illustrating example waveforms of the power converter with controller and bias drive circuit of FIGS. 1A or 1B, in accordance with embodiments of the present disclosure.

FIG. 8 is a is a timing diagram illustrating example waveforms of the power converter with controller and bias drive circuit of FIGS. 1A or 1B, in accordance with embodiments of the present disclosure.

FIG. 9 is a timing diagram illustrating example waveforms of the power converter with controller and bias drive circuit of FIGS. 1A or 1B, in accordance with embodiments of the present disclosure.

FIG. 10 is a timing diagram illustrating example waveforms of the power converter with controller and bias drive circuit of FIGS. 1A or 1B, in accordance with embodiments of the present disclosure.

FIG. 11 is a timing diagram illustrating example waveforms of the power converter with controller and bias drive circuit of FIGS. 1A or 1B, in accordance with embodiments of the present disclosure.

FIG. 12 is a timing diagram illustrating example waveforms of the power converter with controller and bias drive circuit of FIGS. 1A or 1B, in accordance with embodiments of the present disclosure.

FIG. 13 is a schematic diagram of an example isolated power converter including a controller with a bias drive circuit to control a bias switch, in accordance with embodiments of the present disclosure.

FIG. 14 is a schematic diagram of an example isolated power converter including a controller referenced to an output of the power converter with a bias drive circuit to control a bias switch, in accordance with embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

Power converters generally include one or more controllers, which control the turn ON and turn OFF of one or more switches to regulate the output of the power converter. These controllers generally require a regulated or unregulated voltage source to power the circuit components of the controller. A bypass capacitor is one example of a voltage source that may be coupled to a controller and provide a bias supply to circuits of the controller such that the circuits may have the appropriate voltage and/or current to operate. The bypass capacitor is generally regulated to provide sufficient operating power for the controller.

An isolated power converter may include a primary controller, also referred to as a first controller or an input controller, and a secondary controller, also referred to as a second controller or an output controller, which are galvanically isolated from one another by an energy transfer element (e.g., a transformer). In other words, a direct current (dc) voltage applied between input side and output side of the power converter will produce substantially zero current.

The primary controller is configured to control a power switch on the primary side of the power converter to control the transfer of energy from the primary winding of the energy transfer element to the secondary winding of the energy transfer element. The secondary controller is coupled to circuit components on the secondary side of the isolated power converter. It should be appreciated that the primary side may also be referred to as the input side while the secondary side may be referred to as the output side. The secondary controller may also be configured to control a secondary switch coupled to the secondary winding of the energy transfer element, such as a transistor used as a synchronous rectifier for the power converter.

The primary controller may receive a signal, such as a feedback signal, representative of the output of the power converter. In response to the feedback signal, the primary controller controls the switching of the power switch to transfer energy to the secondary side. In another example, the secondary controller may transmit a signal to the primary controller, which controls how the primary controller switches the power switch to transfer energy to the secondary side.

In general, both the primary side and the secondary side of the power converter each includes a bypass capacitor to provide operating power to circuits of the primary controller or the secondary controller, respectively. The bypass capacitor for the primary controller is generally coupled to an auxiliary winding of an energy transfer element, such as a transformer or coupled inductor, and the bypass capacitor is charged from the auxiliary winding. The bias voltage (V_{BIAS}) across the bypass capacitor is generally regulated to a sufficient level to operate circuits of the primary controller. For example, the bias voltage may be regulated to a reference voltage, such as 12 volts (V).

The auxiliary winding voltage (V_{AUX}) is a function of the input voltage (V_{IN}) of the power converter during the on-time of the power switch and is a function of the output voltage (V_{OUT}) of power converter during the off-time of the power switch. For certain applications, the output voltage V_{OUT} may vary between a wide range of values. For example, universal serial bus (USB) Power Delivery (USB-PD) standards may require output voltages between the range of 5V to 48V or greater. The wide range of output voltages introduces a challenge for generating a low voltage bias supply for the primary and secondary controllers in a flyback power converter. The auxiliary winding of a flyback transformer is used to provide the primary controller voltage supply. However, the auxiliary winding voltage V_{AUX} may be proportional to the output voltage Vₒᵤₜ when wound with a flyback polarity. As such, the auxiliary winding may be designed to provide enough power to the primary controller when the output voltage V_{OUT} is at its minimum value. Consequently, when the output voltage V_{OUT} is at its maximum voltage, the auxiliary winding voltage V_{AUX} can be significantly higher. As such, the auxiliary winding voltage V_{AUX} may vary greatly due to the wide range for the output voltage V_{OUT}, but the bias voltage V_{BIAS} is regulated to the reference voltage. In some cases, primary controllers may require a minimum supply voltage of 12V or in some cases approximately 5V (which may be the auxiliary winding voltage V_{AUX}) when the output voltage V_{OUT} is 5V. In this regard, when the output voltage V_{OUT} is at 48V, the auxiliary winding voltage V_{AUX} may be calculated to be about 115V (e.g., (48/5)×12=115V). This 115V potential may need to be reduced to the 12V potential required by the primary controller.

Previous approaches may have utilized a linear regulator to regulate the bias voltage V_{BIAS} to a fixed value. However, at higher output voltages, the current consumption and voltage drop across the linear regulator may lead to significant power dissipation, increasing temperature and reducing the overall efficiency of the power converter. As such, there is a need for more efficient techniques in deriving a primary controller voltage supply.

The subject technology of the present disclosure employs a technique where the auxiliary winding is designed such that it provides the minimum supply voltage required by the primary controller when V_{OUT} is at its minimum value. For all higher values of V_{OUT}, the primary controller employs a switch that is turned on when the primary controller requires power during the flyback period of a switching cycle. The switch may be integrated with the primary controller in some implementations, or may be external to the primary controller in other implementations. During the switch on time current is supplied to a storage capacitor. In such a scheme, for the time that the switch is on, the reflected voltage of the transformer is clamped to a voltage below that which would be generated by the output voltage. As such, substantially no energy is delivered to the output of the power converter while the switch is on. When the storage capacitor has enough charge to operate the primary controller, the switch is turned off and the reflected voltage rises to that generated by V_{OUT} and the energy stored in the transformer is then delivered to the power converter output. The switch can be turned on and off at any time during the flyback period to deliver energy to the storage capacitor. By doing this, the auxiliary winding voltage is clamped to that of the storage capacitor for the duration of the switch on time. As such, there is substantially no voltage drop across the switch, which is in contrast with the previously-described approaches of supplying current to a primary controller involving a linear regulator.

Embodiments of the present disclosure include a bias switch coupled to the auxiliary winding and the bypass capacitor, which provides a bias supply to a controller. In another embodiment of the present disclosure, the bias switch is coupled to the output winding of the power converter and the bypass capacitor, which provides a bias supply to the output or secondary controller. The controller includes a bias drive circuit, which controls the turn ON and turn OFF of the bias switch. In example embodiments, the bias switch is turned ON in response to the bias voltage V_{BIAS} across the bypass capacitor being below a reference. Further, the bias switch is turned ON during the off-time of the power switch. In one example, the bias switch is turned ON until the bias voltage V_{BIAS} reaches the reference. The bias switch may also be turned ON for a threshold duration of time during the off-time of the power switch.

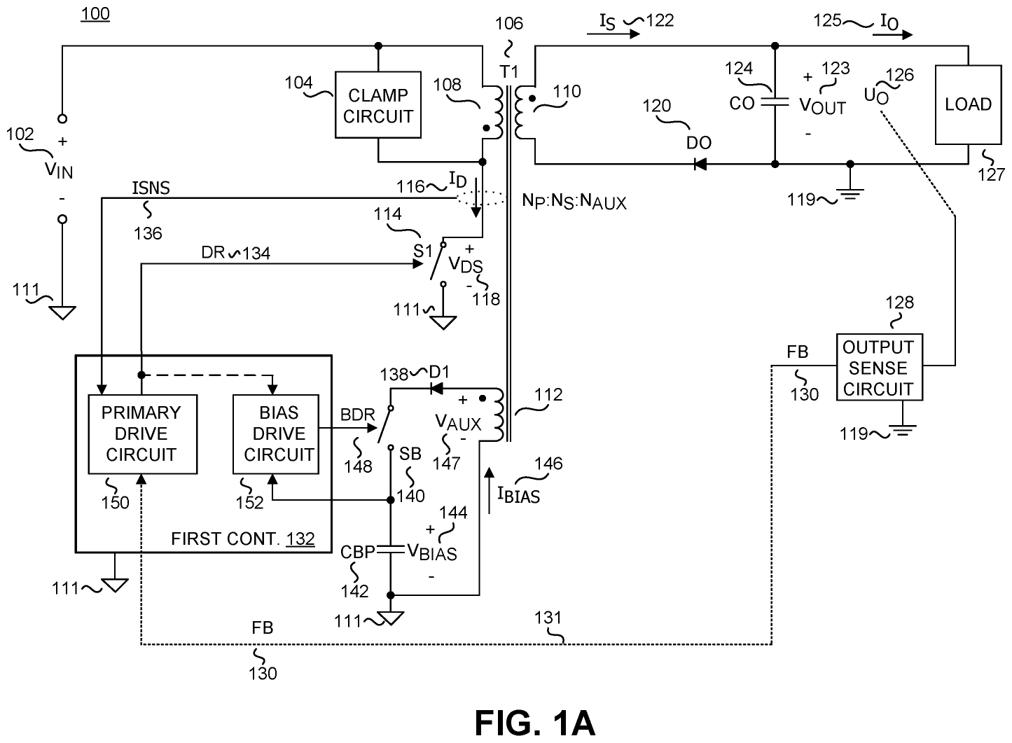

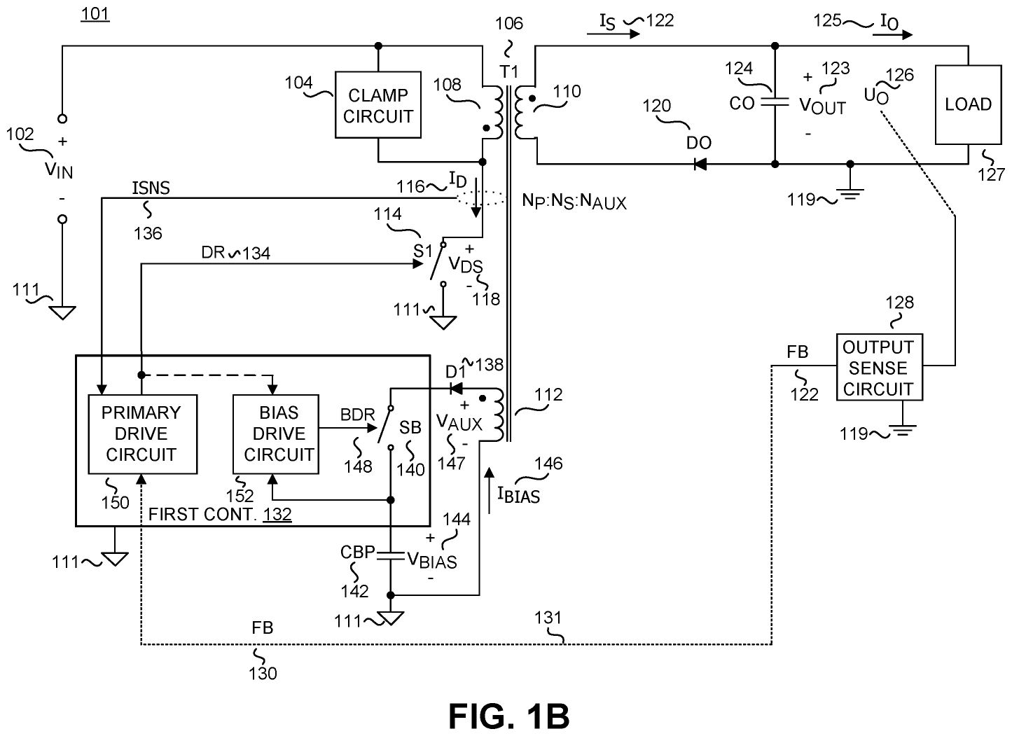

FIG. 1A illustrates a power converter 100 including a first controller 132 (e.g. primary controller) including a bias drive circuit 152 to control a bias switch SB 140, in accordance with embodiments of the present disclosure. The power converter 100 further includes a clamp circuit 104, energy transfer element T1 106, an input winding 108 of the energy transfer element T1 106, an output winding 110 of the energy transfer element T1 106, an auxiliary winding 112 of the energy transfer element T1 106, a power switch S1 114, an input return 111, an output rectifier DO 120, an output capacitor CO 124, an output return 119, an output sense circuit 128, the first controller 132 (e.g. primary controller), a bypass capacitor CBP 144 (e.g. supply capacitor for the first controller 132), and a diode D1 138. A communication link 131 between the output sense circuit 128 and the first controller 132 is also illustrated. The first controller 132 is shown as including a primary drive circuit 150 and a bias drive circuit 152.

Further shown in FIG. 1A are an input voltage V_{IN} 102, a switch current Ip 116, a switch voltage V_{DS} 118, a secondary current Iₛ 122, an output voltage V_{OUT} 123, an output current I_{O} 125, an output quantity Uo 126, a feedback signal FB 130, a drive signal DR 134, a current sense signal ISNS 136, a bias voltage V_{BIAS} 144, a bias current I_{BIAS} 146, an auxiliary winding voltage V_{AUX} 147, and a bias switch drive signal BDR 148.

In the illustrated example, the power converter 100 is shown as having a flyback topology, but it should be appreciated that other known topologies and configurations of power converters may also benefit from the teachings of the present disclosure. Further, the input side of power converter 100 is galvanically isolated from the output side of the power converter 100, such that input return 111 is galvanically isolated from output return 119. Since the input side and output side of power converter 100 are galvanically isolated, there is no direct current (dc) path across the isolation barrier of energy transfer element T1 106, or between input winding 108 and output winding 110, or between auxiliary winding 112 and output winding 110, or between input return 111 and output return 119.

The power converter 100 provides output power to a load 127 from an unregulated input voltage V_{IN} 102. In one embodiment, the input voltage V_{IN} 102 is a rectified and filtered ac line voltage. In another embodiment, the input voltage V_{IN} 102 is a de input voltage. The input voltage V_{IN} 102 is coupled to the energy transfer element T1 106. In some examples, the energy transfer element T1 106 may be a coupled inductor, transformer, or an inductor. The energy transfer element T1 106 is shown as including three windings, input winding 108 (also referred to as a primary winding), output winding 110 (also referred to as a secondary winding), and an auxiliary winding 112 (also referred to as a bias winding or a tertiary winding). The energy transfer element T1 106 is shown as having an input winding 108 with Nₚ number of turns, the output winding 110 with Nₛ number of turns, and the auxiliary winding 112 with N_{Aux} number of turns. However, the energy transfer element T1 106 may have more than three windings.

Coupled across the input winding 108 is the clamp circuit 104. The clamp circuit 104 limits the maximum voltage on the power switch S1 114. The power switch S1 114 is shown as coupled to the input winding 108 and input return 111. In one example, the power switch S1 114 may be a transistor such as a metal-oxide-semiconductor field-effect transistor (MOSFET), bipolar junction transistor (BJT), an insulated-gate bipolar transistor (IGBT), a gallium nitride (GaN) based transistor or a silicon carbide (SiC) based transistor. In another example the power switch S1 114 may be a cascode switch including a normally-on first switch and a normally-off second switch coupled together in a cascode configuration. The first switch may generally be a GaN or SiC based transistor while the second switch may be a MOSFET, BJT, or IGBT.

Output winding 110 is coupled to the output rectifier DO 120, which is exemplified as a diode. However, the output rectifier may be exemplified as a transistor used as a synchronous rectifier. Output capacitor CO 124 is shown as being coupled to the output rectifier DO 120 and the output return 119. The output current I_{O} 125 and output voltage V_{OUT} 123 are provided to the load 127. The power converter 100 further includes circuitry to regulate the output quantity Uo 126, which in one example may be the output voltage V_{OUT} 123, output current I_{O} 125, or a combination of the two. For the example shown, the output sense circuit 128 is configured to sense the output quantity Uo 126 to provide the feedback signal FB 130, representative of the output (e.g. the output quantity Uo 126) of the power converter 100, to the first controller 132.

The first controller 132 receives the feedback signal FB 130 via a communication link 131 which provides galvanic isolation. The communication link 131 may provide galvanic isolation utilizing an inductive coupling (such as a transformer or a coupled inductor, an optocoupler), capacitive coupling, or other device could be utilized for the communication link 131 and maintain the galvanic isolation.

The first controller 132 controls the turn ON and turn OFF of the power switch S1 114 in response to the feedback signal FB 130. As used herein, the power switch S1 114 that is turned ON may conduct current, and can be referred to as being transitioned into a conducting state. Accordingly, the power switch S1 114 that is ON can be referred to as being in the conducting state. The power switch S1 114 that is turned OFF may not conduct current, and can be referred to as being transitioned into a non-conducting state. Accordingly, the power switch S1 114 that is OFF can be referred to as being in the non-conducting state. In one example, the first controller 132 may be formed as part of an integrated circuit die that is manufactured as either a hybrid or monolithic integrated circuit. A portion of the power switch S1 114 may also be integrated in the same integrated circuit die as the first controller 132 or could be formed on its own integrated circuit die or dies. Further, it should be appreciated that both the first controller 132 and power switch S1 114 need not be included in a single package and may be implemented in separate controller packages or a combination of combined/separate package.

As illustrated in FIG. 1A, the first controller 132 includes the primary drive circuit 150 and the bias drive circuit 152. The primary drive circuit 150 is coupled to receive the feedback signal FB 130 and outputs the drive signal DR 134 to control the turn ON and turn OFF of the power switch S1 114. For example, the primary drive circuit 150 may cause the primary switch S1 114 to transition between a conducting state during a first portion of a switching cycle and a nonconducting state during a second portion of the switching cycle. The primary drive circuit 150 may also receive the current sense signal ISNS 136 representative of the switch current ID 116 of the power switch S1 114. The primary drive circuit 150 provides the primary drive signal DR 134 to the power switch S1 114 to control various switching parameters of the power switch S1 114 to control the transfer of energy from the input of to the output of the power converter 100 through the energy transfer element T1 106 to regulate the output of power converter 100, such as the output quantity Uo 126. Example of such parameters include switching frequency f_{SW} (or switching period T_{SW}), duty cycle, on-time and off-times, or varying the number of pulses per unit time of the power switch S1 114. In addition, the power switch S1 114 may be controlled such that it has a fixed switching frequency or a variable switching frequency.

In one embodiment, the primary drive circuit 150 of the first controller 132 outputs the drive signal DR 134 to control the conduction of power switch S1 114. In particular, the drive signal DR 134 is provided to control the turn ON of the power switch S1 114 in response to the feedback signal FB 130. In one example, the drive signal DR 134 is a rectangular pulse waveform with high and low sections. High sections may correspond to the power switch S1 114 being ON while low sections correspond to the power switch S1 114 being OFF, or vice versa. While the power switch S1 114 is conducting, energy is stored in the energy transfer element T1 106. The primary drive circuit 150 may control the turn OFF of the power switch S1 114 in response to the feedback signal FB 130. In another embodiment, the primary drive circuit 150 may control the turn OFF of the power switch S1 114 in response to the switch current ID 116 provided by the current sense signal ISNS 136 reaching a current limit. It should be appreciated that other control methods may be used. For the power converter 100 shown in FIG. 1A, when the power switch S1 114 is not conducting, energy stored in the energy transfer element T1 106 is transferred to the output winding 110 or to the auxiliary winding 112.

Energy transfer element T1 106 includes the auxiliary winding 112 referenced to input return 111. In one embodiment, the bias switch SB 140 is coupled to the auxiliary winding 112 having a same input return as the input winding 108. The auxiliary winding 112 is shown as coupled to the diode D1 138 and the bypass capacitor CBP 142. For the power converter 100 shown in FIG. 1A, the bias voltage V_{BIAS} 144 of the bypass capacitor CBP 142 can be derived from the auxiliary winding voltage V_{AUX} 147 across the auxiliary winding 112. Bypass capacitor CBP 142 is coupled to the first controller 132 to provide bias power for the circuits of the first controller 132. In other words, the bias voltage V_{BIAS} 144 is generally regulated to a sufficient level to operate circuits of the first controller 132.

Bias switch SB 140 is shown as coupled to the bypass capacitor CBP 142 and the first controller 132 controls the turn ON and OFF of the bias switch SB 140. Bypass capacitor CBP 142 is the voltage source for the first controller 132 which provides bias supply to the internal circuits of the first controller 132 such that the internal circuits have the appropriate voltage and/or currents to operate. As used herein, the bias switch SB 140 that is turned ON may conduct current, and can be referred to as being transitioned into a conducting state. Accordingly, the bias switch SB 140 that is ON can be referred to as being in the conducting state. The bias switch SB 140 that is turned OFF may not conduct current, and can be referred to as being transitioned into a non-conducting state. Accordingly, the bias switch SB 140 that is OFF can be referred to as being in the non-conducting state.

When the bias switch SB 140 is conducting, energy is transferred to the auxiliary winding 112 and to the bypass capacitor CBP 142. Bias current I_{BIAS} 146 is produced and the bypass capacitor CBP 142 is charged. As such, the bias voltage V_{BIAS} 144 increases. The turning ON and OFF of the bias switch SB 140 regulates the voltage V_{BIAS} 144 of the bypass capacitor CBP 142 such that the bypass capacitor CBP 142 may provide sufficient operating power for the first controller 132.

The bias drive circuit 152 receives the bias voltage V_{BIAS} 144 and outputs the bias drive signal BDR 148 to control the turn ON and turn OFF of the bias switch SB 140. In one example, the bias drive circuit 152 may also receive a signal representative of the off-time of power switch S1 114 and outputs the bias drive signal BDR 148 to control the turn ON and turn OFF of the bias switch SB 140. In one example, because diode D1 138 blocks the flow of current I_{BIAS} 146 during the on-time of power switch S1 114, the bias drive circuit 152 may output the bias drive signal BDR 148 to control the turn ON of the bias switch SB 140 if V_{BIAS} 144 falls below the reference prior to the start of the off-time of power switch S1 114. In other words, the bias drive circuit 152 may control operation of the bias switch SB 140 during a part of the first portion of the switching cycle. However, the bias current I_{BIAS} 146 is provided to the bypass capacitor CBP 142 for providing a bias supply during at least part of the second portion of the switching cycle. In a further example, the bias drive circuit 152 may control operation of the bias switch SB 140 during at least part of the second portion of the switching cycle to drive the bias current I_{BIAS} 146 to the bypass capacitor CBP 142 for providing a bias supply to the first controller 132. In one example, the bias drive signal BDR 148 is a rectangular pulse waveform of high and low sections. High sections may correspond to the bias switch SB 140 being ON while low sections may correspond to the bias switch SB 140 being OFF, or vice versa. The bias drive circuit 152 may be coupled to receive the drive signal DR 134 as the signal representative of the off-time of power switch S1 114, as shown by the dashed line. In some implementations, the bias drive circuit 152 can cause the bias switch SB 140 to transition into a conducting state during at least part of the second portion of the switching cycle based on the signal representative of the off-time of power switch S1 114 from the primary drive circuit 150. It should be appreciated, however, that other signals may be utilized to represent the off-time of the power switch S1 114. For example, the switch voltage V_{Ds} 118 may also be utilized to extract information regarding the off-time of the power switch S1 114.

The bias drive circuit 152 controls the turn ON and OFF of the bias switch SB 140 to regulate the bias voltage V_{BIAS} 144 across the bypass capacitor CBP 142. For example, the bias drive circuit 152 can cause conduction of the bias current I_{BIAS} 146 in the auxiliary winding 112 during at least part of the second portion of the switching cycle with the bias switch SB 140 in the conducting state and substantially no current is conducted in the auxiliary winding 112 during the first portion of the switching cycle with the bias switch SB 140 in the nonconducting state. In some embodiments, the bias drive circuit 152 can cause the bias switch SB 140 to transition into a conducting state during at least part of the second portion of the switching cycle based on a comparison between the bias voltage V_{BIAS} 144 across the bypass capacitor CBP 142 and a reference. For example, the bias drive circuit 152 turns ON the bias switch SB 140 in response to the bias voltage V_{BIAS} 144 falling below the reference. In some embodiments, the bias switch SB 140 is turned ON during the off-time of the power switch S1 114. As such, at least a portion of the energy stored in the energy transfer element T1 106 during the on-time of power switch S1 114 is transferred to the bias capacitor CBP 142 instead of the output of the power converter 100 if the bias voltage V_{BIAS} 144 is below the reference during the off-time of the power converter S1 114. In other words, the bias drive circuit 152 turns ON the bias switch SB 140 such that the current (e.g. bias current I_{BIAS} 146) flows through the auxiliary winding 112 rather than through the output winding 110 (e.g. secondary current Iₛ 122). In some implementations, the bias switch SB 140 in the nonconducting state allows the secondary current Iₛ 122 to flow through the output winding 110. As used herein, the “on-time of power switch S1 114” can refer to the “first portion of the switching cycle” and the “off-time of power switch S1 114” can refer to the “second portion of the switching cycle.”

However, it should be appreciated that energy may be transferred to either the auxiliary winding 112 or the output winding 110 depending on the number of turns N_{AUX}, Nₛ and the respective voltages across these windings. The turns ratio of the windings should be chosen such that the energy will be transferred to the auxiliary winding 112 and bypass capacitor CBP 142 in response to the first controller 132 determining that the bias voltage V_{BIAS} 144 is out of regulation. Or in other words, the turns ratio of the windings should be chosen such that the energy will be transferred to the auxiliary winding 112 and bypass capacitor CBP 142 in response to the bias drive circuit 152 controlling the turn ON and conduction of the bias switch SB 140. As such, the turns ratio (Nₛ, N_{AUX}, Nₚ) may be chosen such that the reflected voltage across the input winding 108 when energy is being transferred to the auxiliary winding 112 is lower than the reflected voltage across the input winding 108 when energy is being transferred to the output winding 110.

For example, the reflected voltage across the input winding 108 when energy is being transferred to the output winding 110, e.g. voltage V_{OR}, is substantially the product of the output voltage V_{OUT} 123 and the turns ratio between the input winding Nₚ and the output winding Nₛ, or mathematically:

$${V}_{OR} = \frac{{N}_{P}}{{N}_{S}} {V}_{OUT} \qquad ( 1 )$$

The reflected voltage across the input winding 108 when the energy is being transferred to the auxiliary winding 112, e.g. voltage V_{BR}, is substantially the product of the auxiliary winding voltage V_{AUX} 147 and the turns ratio between the input winding Nₚ and the auxiliary winding N_{AUX}, or mathematically:

$${V}_{BR} = \frac{{N}_{P}}{{N}_{AUX}} {V}_{AUX} \qquad ( 2 )$$

As such, the selection for turns Nₛ and N_{Aux} may be selected such that the ratio of the output voltage V_{OUT} 123 to turns Nₛ is greater than the ratio of the auxiliary winding voltage V_{AUX} 147 to turns N_{AUX}, or mathematically:

$$\frac{{V}_{OUT}}{{N}_{S}} > \frac{{V}_{AUX}}{{N}_{AUX}} \qquad ( 3 )$$

In one embodiment, the bias drive circuit 152 is configured to cause the bias switch SB 140 to transition between a conducting state and a nonconducting state based on the bias voltage V_{BIAS} 144 across the bypass capacitor CBP 142. For example, the bias drive circuit 152 turns ON the bias switch SB 140 if the bias voltage V_{BIAS} 144 falls below the reference. If the bias voltage V_{BIAS} 144 falls below the reference prior to the start of the off-time of power switch S1 114, the bias drive circuit 152 may turn ON the bias switch SB 140 at the beginning of the off-time of power switch S1 114. In another example, the bias drive circuit 152 may turn ON the bias switch SB 140 a delay period after the beginning of the off-time of power switch S1 114. In another example, because diode D1 138 blocks the flow of current I_{BIAS} 146 during the on-time of power switch S1 114, if V_{BIAS} 144 falls below the reference prior to the start of the off-time of power switch S1 114, the bias drive circuit 152 may turn ON the bias switch SB 140 before the beginning of the off-time of power switch S1 114. However, the bias current I_{BIAS} 146 flows once the power switch S1 114 is turned OFF. In a further embodiment, if the bias voltage V_{BIAS} 144 falls below the reference during the off-time of the power switch S1 114, the bias drive circuit 152 turns ON the bias switch SB 140 such that current (e.g. bias current I_{BIAS} 146) flows through the auxiliary winding 112 rather than the output winding 110 (e.g. secondary current Iₛ 122).

The bias drive circuit 152 turns OFF the bias switch SB 140 if the bias voltage V_{BIAS} 144 exceeds the reference. The bias drive circuit 152 may also turn OFF the bias switch SB 140 if the bias switch SB 140 is ON for a threshold duration TTH. In a further example, the bias drive circuit 152 turns OFF the bias switch SB 140 if the bias current I_{BIAS} 146 reaches zero. As will be further discussed, the bias drive circuit 152 may sense that the bias current I_{BIAS} 146 has reached zero from directly sensing the bias current I_{BIAS} 146. Alternatively, the bias drive circuit 152 may sense that the bias current I_{BIAS} 146 has reached zero by sensing the auxiliary winding voltage V_{AUX} 147. In this regard, the bias drive circuit 152 can cause the bias switch SB 140 to transition into the conducting state based on the auxiliary winding voltage V_{AUX} 147.

As such, the first controller 132 may regulate the bias voltage V_{BIAS} 144 across the bypass capacitor CBP 142 to operate internal circuits of the first controller 132.

FIG. 1B illustrates a power converter 101 which is substantially similar to power converter 100 shown in FIG. 1A and similarly named and numbered elements couple and function as described above. At least one difference, however, is the first controller 132 is shown as also including the bias switch SB 140. The bias switch SB 140 may be integrated into the same integrated circuit as the first controller 132.

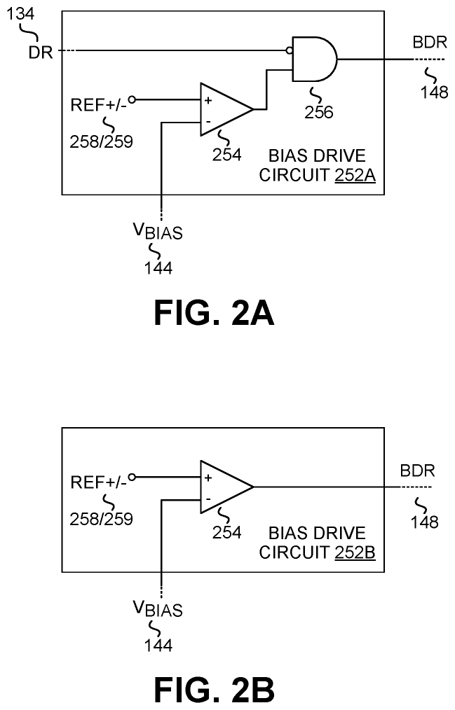

FIG. 2A illustrates bias drive circuit 252A including a comparator 254, and logic gate 256 shown as an AND gate. It should be appreciated that similarly named and numbered elements couple and function as described above. Bias drive circuit 252A is coupled to receive the drive signal DR 134, bias voltage V_{BIAS} 144, and outputs the bias drive signal BDR 148.

Comparator 254 is coupled to receive the bias voltage V_{BIAS} 144 and upper reference REF+258 and lower reference REF−259. As shown, the bias voltage V_{BIAS} 144 is received at the inverting input of comparator 254 while the upper reference REF+258 and lower reference REF−259 are received at the non-inverting input of comparator 254. The value of upper reference REF+258 is greater than the value of lower reference REF−259. The comparator 254 is shown as receiving two values at its non-inverting input to indicate that comparator 254 utilizes hysteresis. In operation, the output of comparator 254 is high in response to the bias voltage V_{BIAS} 144 reaching or being less than the lower reference REF−259. The output of comparator 254 is low in response to the bias voltage V_{BIAS} 144 reaching or being greater than the upper reference REF+258. In other words, the output of comparator 254 does not transition to a logic low value from a logic high value until the bias voltage V_{BIAS} 144 has reached or is greater than the upper reference REF+258. Similarly, the output of comparator 254 does not transition to a logic high value from a logic low value until the bias voltage V_{BIAS} 144 has fallen below the lower reference REF−258.

Logic gate 256 is coupled to receive the output of comparator 254 and the inverted drive signal DR 134, as indicated by the small circle at the input of logic gate 256. The output of logic gate 256 is the bias drive signal BDR 148. For the example shown, the high sections for drive signal DR 134 correspond to the on-time of the power switch S1 114 while low sections for drive signal DR 134 correspond to the off-time of the power switch S1 114. As such, high sections of the inverted drive signal DR 134 correspond to the off-time of power switch S1 114 while low sections correspond with the on-time of the power switch S1 114.

In operation, the bias drive circuit 252A outputs a high value for the bias drive signal BDR 148, indicating to control the bias switch SB 140 ON, and outputs a low value for the bias drive signal BDR 148, indicating to control bias switch SB 140 OFF. In some implementations, the bias drive circuit 252A drives the bias drive signal BDR 148 to a first value that causes the bias switch SB 140 to transition into the conducting state when the bias voltage V_{BIAS} 144 is lower than a first reference (e.g., lower reference REF−259). In this regard, the bias drive signal BDR 148 can be driven to the first value for a duration during which the bias voltage V_{BIAS} 144 is increased towards a second reference (e.g., upper reference REF+258). In one example, the first value may represent a turn-on voltage or a turn-on current for the bias switch SB 140. For example, the output of logic gate 256, e.g. bias drive signal BDR 148, is high to control the bias switch SB 140 ON if the drive signal DR 134 indicates the power switch S1 114 is OFF and the bias voltage V_{BIAS} 144 has fallen below the lower reference REF−259. In some implementations, the bias drive circuit 252A drives the bias drive signal BDR 148 to a second value smaller than the first value that causes the bias switch SB 140 to transition into the nonconducting state when the bias voltage V_{BIAS} 144 reaches the second reference (e.g., upper reference REF+258) or the signal representative of the conducting state of the primary switch S1 114 from the primary drive circuit 150 indicates that the primary switch S1 114 is in the conducting state. In one example, the second value may represent a turn-off voltage or a turn-off current for the bias switch SB 140. For example, the output of logic gate 256, e.g. bias drive signal BDR 148, is low to control the bias switch SB 140 OFF if the bias voltage V_{BIAS} 144 has reached or is greater than the upper reference REF+258 or if the drive signal DR 134 indicates that the power switch S1 114 is ON.

FIG. 2B illustrates bias drive circuit 252B including comparator 254. It should be appreciated that similarly named and numbered elements couple and function as described above with respect to FIG. 2A. Bias drive circuit 252B is coupled to receive the bias voltage V_{BIAS} 144, and outputs the bias drive signal BDR 148. Comparator 254 is coupled to receive the bias voltage V_{BIAS} 144 and upper reference REF+258 and lower reference REF−259. As shown, the bias voltage V_{BIAS} 144 is received at the inverting input of comparator 254 while the upper reference REF+258 and lower reference REF−259 are received at the non-inverting input of comparator 254. The value of upper reference REF+258 is greater than the value of lower reference REF−259. The comparator 254 is shown as receiving two values at its non-inverting input to indicate that comparator 254 utilizes hysteresis. In operation, the output of comparator 254 (e.g. bias drive signal BDR 148) is high in response to the bias voltage V_{BIAS} 144 reaching or being less than the lower reference REF−259. The output of comparator 254 (e.g. bias drive signal BDR 148) is low in response to the bias voltage V_{BIAS} 144 reaching or being greater than the upper reference REF+258. In other words, the output of comparator 254 does not transition to a logic low value from a logic high value until the bias voltage V_{BIAS} 144 has reached or is greater than the upper reference REF+258. Similarly, the output of comparator 254 does not transition to a logic high value from a logic low value until the bias voltage V_{BIAS} 144 has fallen below the lower reference REF−258. As such, for the example shown in FIG. 2A, the bias drive circuit 252B outputs the bias drive signal BDR 148 to control the bias switch SB 140 ON when the bias voltage V_{BIAS} 144 is less than the lower reference REF−259 and outputs the bias drive signal BDR 148 to control the bias switch SB 140 OFF when the bias voltage V_{BIAS} 144 reaches the upper reference REF+258.

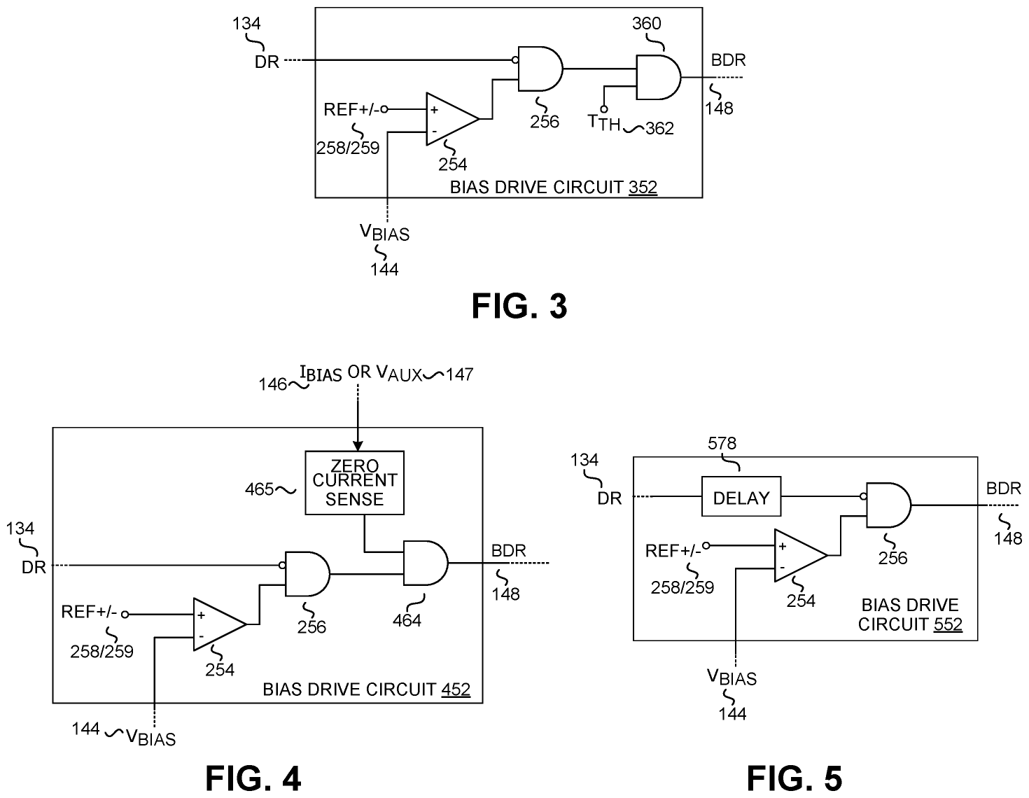

FIG. 3 illustrates bias drive circuit 352 including a comparator 254, logic gate 256 shown as an AND gate, and logic gate 360 shown as AND gate. It should be appreciated that similarly named and numbered elements couple and function as described above. Bias drive circuit 352 is coupled to receive the drive signal DR 134, bias voltage V_{BIAS} 144, threshold duration signal TTH 362, and outputs the bias drive signal BDR 148.

Bias drive circuit 352 shares many similarities as bias drive circuits 252A, 252B of FIGS. 2A and 2B, and similarly named and numbered elements couple and function as described above. At least one difference, however, is the logic gate 360 is coupled to receive the output of logic gate 256 and the threshold duration signal TTH 362 and outputs the bias drive signal BDR 148. The bias drive circuit 352 controls the turn ON and OFF of bias switch SB 140 and limits the on-time of the bias switch SB 140 to less than or equal to a threshold period TTH. For example, the bias drive circuit 352 can cause the bias switch SB 140 to transition into the conducting state during at least part of the second portion of the switching cycle based on the threshold duration TTH corresponding to at least part of the second portion of the switching cycle. In some aspects, the threshold duration signal TTH 362 is representative of the on-time limit for the bias switch SB 140. In other words, the threshold duration signal TTH 362 is representative of the threshold period TTH. For the example shown, the threshold duration signal TTH 362 is a rectangular pulse waveform of high and low sections. The threshold duration signal TTH 362 may transition to a high value coincident with the bias switch SB 140 turning ON. The duration of the high section may be substantially equal to a threshold period TTH. As used herein, the “on-time of bias switch SB 140” can refer to the “second portion of the switching cycle” and the “off-time of bias switch SB 140” can refer to the “first portion of the switching cycle.”

Logic gate 360 acts as a gating element which allows the output of logic gate 356 to pass as the bias drive signal BDR 148 in response the threshold duration signal TTH 362. In operation, the output of logic gate 360, e.g. bias drive signal BDR 148, is high to control the bias switch SB 140 ON if the power switch S1 114 is turned OFF, the bias voltage V_{BIAS} 144 has fallen below the lower reference REF−259, and the on-time of the bias switch SB 140 is less than the threshold duration TTH. The output of logic gate 360, e.g. bias drive signal BDR 148, is low to control the turn OFF of the bias switch SB 140 if the bias voltage V_{BIAS} 144 has reached or is greater than the upper reference REF+258, if the drive signal DR 134 indicates that the power switch S1 114 is ON, or if the on-time of the bias switch SB 140 has reached the threshold duration TTH.

FIG. 4 illustrates bias drive circuit 452 including a comparator 254, logic gate 256 shown as an AND gate, logic gate 464 shown as AND gate, and zero current sense circuit 465. It should be appreciated that similarly named and numbered elements couple and function as described above. Bias drive circuit 452 is coupled to receive the drive signal DR 134, bias voltage V_{BIAS} 144, and a sense signal representative of bias current I_{BIAS} 146. As shown, the sense signal representative of the bias current I_{BIAS} 146 may be the bias current I_{BIAS} 146 or the auxiliary winding voltage V_{AUX} 147.

Bias drive circuit 452 shares many similarities as bias drive circuits 252A, 252B of FIGS. 2A and 2B, and similarly named and numbered elements couple and function as described above. At least one difference, however, is the logic gate 464 and the zero current sense circuit 465. The bias drive circuit 452 controls the turn ON and OFF of the bias switch SB 140 and can also determine to turn OFF the bias switch SB 140 if the bias current I_{BIAS} 146 reaches substantially zero. When the power switch S1 114 is OFF, a non-zero current in the auxiliary winding 112 or the output winding 110 (e.g. bias current I_{BIAS} 146 or secondary current Iₛ 122) is an indication that energy is being transferred. Once the current in the auxiliary winding 112 or the output winding 110 falls to zero, there is no energy stored in the energy transfer element T1 106. The bias drive circuit 452 senses that the energy has been transferred by sensing that the bias current I_{BIAS} 146 has reached zero and turns off the bias switch SB 140.

As shown, the zero current sense circuit 465 is coupled to receive the sense signal representative of the bias current I_{BIAS} 146, which may be the bias current I_{BIAS} 146 or the auxiliary winding voltage V_{AUX} 147. The zero current sense circuit 465 determines if the bias current I_{BIAS} 146 has reached zero and asserts an output to logic gate 464 in response to sensing the bias current I_{BIAS} 146.

Logic gate 464 is coupled to receive the output of logic gate 256 and the output of the zero current sense circuit 465 and outputs the bias drive signal BDR 148. Logic gate 464 acts as a gating element which allows the output of logic gate 256 to pass as the bias drive signal BDR 148 in response to the output of the zero current sense circuit 465. In some implementations, the bias drive circuit 452 drives the bias drive signal BDR 148 to a first value that causes the bias switch SB 140 to transition into the conducting state when the bias voltage V_{BIAS} 144 is lower than a first reference (e.g., lower reference REF−259). In this regard, the bias drive signal BDR 148 can be driven to the first value for a duration during which the bias voltage V_{BIAS} 144 is increased towards a second reference (e.g., upper reference REF+258) and the bias current I_{BIAS} 146 has not reached zero current. For example, the output of logic gate 464, e.g. bias drive signal BDR 148, is high to control the bias switch SB 140 ON if the power switch S1 114 is turned OFF, the bias voltage V_{BIAS} 144 has fallen below the lower reference REF−259, and the bias current I_{BIAS} 146 is non-zero. In some implementations, the bias drive circuit 452 drives the bias drive signal BDR 148 to a second value smaller than the first value that causes the bias switch SB 140 to transition into the nonconducting state when the bias voltage V_{BIAS} 144 reaches the second reference (e.g., upper reference REF+258), the signal representative of the conducting state of the primary switch S1 114 from the primary drive circuit 150 indicates that the primary switch S1 114 is in the conducting state, or the bias current I_{BIAS} 146 has reached zero current. The output of logic gate 464, e.g. bias drive signal BDR 148, is low to control the turn OFF of the bias switch SB 140 if the bias voltage V_{BIAS} 144 has reached or is greater than the upper reference REF+258, if the drive signal DR 134 indicates that the power switch S1 114 is ON, or the bias current I_{BIAS} 146 has reached zero.

FIG. 5 illustrates bias drive circuit 552 including a comparator 254, logic gate 256 shown as an AND gate, logic gate 464 shown as AND gate, and delay circuit 578. It should be appreciated that similarly named and numbered elements couple and function as described above. Bias drive circuit 552 is coupled to receive the drive signal DR 134 and bias voltage V_{BIAS} 144.

Bias drive circuit 552 shares many similarities as bias drive circuits 252A, 252B of FIGS. 2A and 2B and similarly named and numbered elements couple and function as described above. At least one difference, however, is the delay circuit 578 is configured to receive the drive signal DR 134. The bias drive circuit 552 controls the turn ON and OFF of the bias switch SB 140 and delays the turn ON of the bias switch SB 140. In particular, the bias drive circuit 552 controls the turn ON of the bias switch SB 140 such that the bias switch SB 140 cannot be turned on until a delay period TDELAY after the power switch S1 114 turns OFF. In some implementations, the bias drive circuit 552 can cause the bias switch SB 140 to transition into the conducting state during at least part of the second portion of the switching cycle based on a delayed version of the signal representative of the conducting state of the primary switch S1 114 from the primary drive circuit 150.

As shown, the delay circuit 578 is coupled to receive the drive signal DR 134. The inverted and delayed drive signal DR 134 is received by the logic gate 256. Logic gate 256 also receives the output of comparator 254. The output of logic gate 256 is the bias drive signal BDR 148. It should be appreciated that the delay circuit 578 may be a leading edge delay circuit and delays leading edges in the drive signal DR 134 by the delay period TDELAY.

In operation, the bias drive circuit 552 outputs a high value for the bias drive signal BDR 148, indicating to control the bias switch SB 140 ON, and outputs a low value for the bias drive signal BDR 148, indicating to control bias switch SB 140 OFF. The output of logic gate 256, e.g. bias drive signal BDR 148, is high to control the bias switch SB 140 ON if the drive signal DR 134 indicates the power switch S1 114 is OFF and the bias voltage V_{BIAS} 144 has fallen below the lower reference REF−259. However, the bias drive signal BDR 148 does not control the turn ON of the bias switch SB 140 until at least a delay period TDELAY after the power switch S1 114 turns OFF. The output of logic gate 256, e.g. bias drive signal BDR 148, is low to control the bias switch SB OFF if the bias voltage V_{BIAS} 144 has reached or is greater than the upper reference REF+258 or if the drive signal DR 134 indicates that the power switch S1 114 is ON.

It should be appreciated that the features of bias drive circuits 252A, 252B, 352, 452, and 552 may be used wholly or in part together.

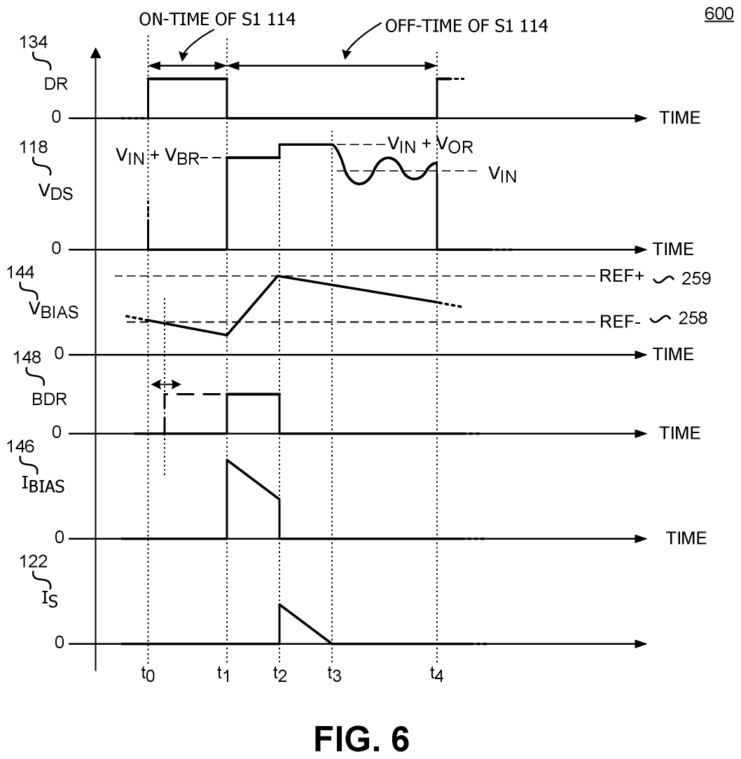

FIG. 6 illustrates timing diagram 600 of example waveforms for the drive signal DR 134, switch voltage V_{DS} 118 of power switch S1 114, bias voltage V_{BIAS} 144 across bypass capacitor CBP 142, bias drive signal BDR 148, bias current I_{BIAS} 146, and secondary current Iₛ 122. FIG. 6 illustrates controlling the turn ON and turn OFF of the bias switch SB 140 in response to the bias voltage V_{BIAS} 144 falling below the lower reference REF−258 and reaching the upper reference REF+259. It should be appreciated that FIG. 6 illustrates one example of controlling the bias switch SB 140 ON when the bias voltage V_{BIAS} 144 falls below the lower reference REF−258 and another example of the controlling the bias switch SB 140 ON when the bias voltage V_{BIAS} 144 falls below the lower reference REF−258 and the power switch S1 114 is controlled OFF.

For the examples shown, drive signal DR 134 and the bias drive signal BDR 148 are rectangular pulse waveforms of high and low sections. High sections correspond with the power switch S1 114 or bias switch SB 140 being ON, respectively, while low sections correspond with the power switch S1 114 or bias switch SB 140 being OFF, respectively.

At time to, the drive signal DR 134 transitions to a high value and the power switch S1 114 is controlled ON. The transition indicates the beginning of the on-time of power switch S1 114 and energy is stored in the energy transfer element. For the example shown, the duration between times t₀ and t₁ is the on-time of the power switch S1 114 and the switch voltage V_{DS} 118 falls to substantially zero. Energy is stored as a current in the input winding 108 of the energy transfer element T1 106. The bias drive signal BDR 148 is low and bias switch SB 114 is controlled OFF. Bias current I_{BIAS} 146 and secondary current Iₛ 122 are substantially zero, indicating no current flow in either the auxiliary winding 112 or the output winding 110.

Between times t₀ and t₁, the bias voltage V_{BIAS} 144 is decreasing. As shown, the bias voltage V_{BIAS} 144 has fallen below the lower reference REF−258.

At time t₁, the drive signal DR 134 transitions to a low value and power switch S1 114 is controlled OFF. The transition indicates the beginning of the off-time of the power switch S1 114 and energy is transferred to either the output winding 110 or the auxiliary winding 112. Since the bias voltage V_{BIAS} 144 has fallen below the lower reference REF−258, the bias drive signal BDR 148 transitions to a high value to control the turn ON of bias switch SB 140. The switch voltage V_{Ds} 118 increases and is substantially the sum of the input voltage V_{IN} 102 and the reflected voltage across the input winding 108 due to the auxiliary winding, e.g. voltage V_{BR} of equation (2) above, or mathematically: V_{DS}=V_{IN}+V_{BR}=V_{IN}+N_{P}/N_{AUX} V_{AUX}.

Alternatively, as shown by the dashed lines for the bias drive signal BDR 148 in FIG. 6, the bias drive signal BDR 148 transitions to a logic high value to control the turn ON of bias switch SB 140 when the bias voltage V_{BIAS} 144 has fallen below the lower reference REF−258 between time t₀ and time t₁. Although the bias switch SB 140 may be ON during a portion of the on-time of the power switch S1 114, the diode D1 138 blocks the flow of current I_{BIAS} 146 during the on-time of power switch S1 114. The bias current I_{BIAS} 146 does not flow until the power switch S1 114 is turned OFF. It should be appreciated that the bias drive signal BDR 148 may transition to a logic high value to control the turn ON of bias switch SB 140 any time after the bias voltage V_{BIAS} 144 has fallen below the lower reference REF−258 during the on-time of the power switch S1 114. Further, the bias drive signal BDR 148 may transition to a logic high value to control the turn ON of bias switch SB 140 prior to the bias voltage V_{BIAS} 144 falling below the lower reference REF−258 during the on-time of the power switch S1 114. The small bidirectional arrow shown illustrates that the transition to the logic high value may vary for the bias drive signal BDR 148 during the on-time of the power switch S1 114 for the switching cycle shown.

While the bias switch SB 140 is controlled ON and conducting, the energy is transferred from the energy transfer element T1 106 in the form of a current. A non-zero current (e.g., bias current I_{BIAS} 146) flows through auxiliary winding 112, the bypass capacitor CBP 142 is charged, and the bias voltage V_{BIAS} 144 increases. Energy is transferred to the auxiliary winding 112 and not the output winding 110, as such the secondary current is substantially zero.

At time t₂, the bias voltage V_{BIAS} 144 reaches the upper reference REF+. The bias drive signal BDR 148 transitions to a low value and controls the bias switch SB 140 OFF. Energy is transferred to the output winding 110 and a non-zero secondary current Iₛ 122 flows through output winding 110. As shown, the switch voltage V_{Ds} 118 is substantially the sum of the input voltage V_{IN} 102 and the reflected voltage across the input winding 108 due to the output winding 110, e.g. voltage V_{OR} of equation (1) above, or mathematically: V_{DS}=V_{IN}+V_{OR}=V_{IN}+N_{P}/N_{S} V_{OUT}. It should be appreciated that the reflected voltage due to the output winding 110, e.g. voltage V_{OR}, is greater than the reflected voltage due to the auxiliary winding 112, e.g. voltage V_{BR}. The bias voltage V_{BIAS} 144 begins to decrease since there is no current charging the bypass capacitor CBP 142.

At time t₃, the secondary current Iₛ 122 reaches zero, indicating that the energy previously stored in the energy transfer element T1 106 has been transferred. As such, ringing occurs (also referred to as a relaxation ring) on waveform V_{Ds} 118 due to the parasitic inductances and capacitances. For the example shown, the relaxation ring oscillates around the input voltage V_{IN} 102. At time t4, the drive signal DR 134 transitions to a high value to control the power switch S1 114 ON. The duration between times t₁ and t₂ is the off-time of the power switch S1 114.

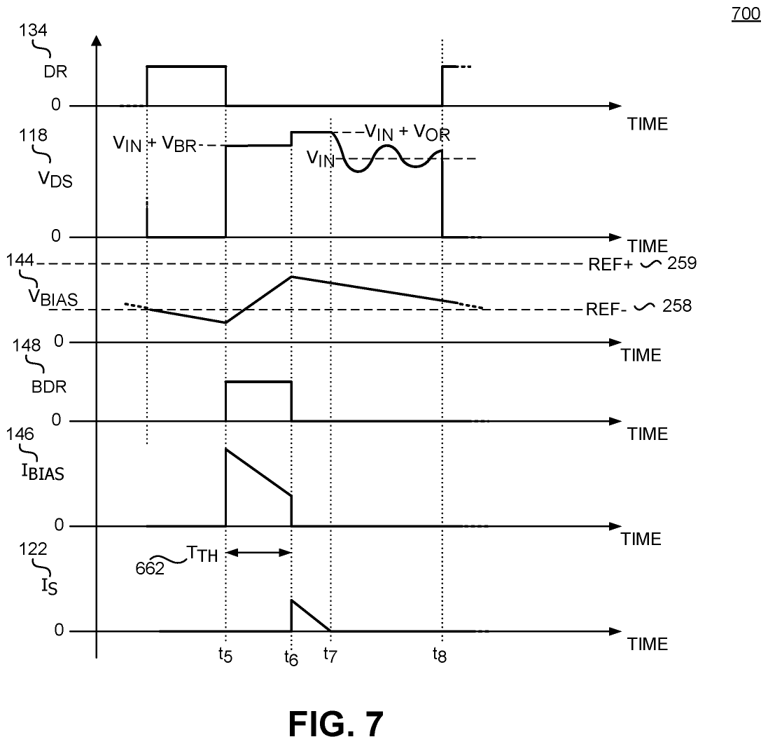

FIG. 7 illustrates timing diagram 700 of example waveforms for the drive signal DR 134, switch voltage V_{Ds} 118 of power switch S1 114, bias voltage V_{BIAS} 144 across bypass capacitor CBP 142, bias drive signal BDR 148, bias current I_{BIAS} 146, and secondary current Iₛ 122. FIG. 7 illustrates controlling the turn ON of the bias switch SB 140 in response to the bias voltage V_{BIAS} 144 falling below the lower reference REF−258 and controlling the turn OFF of the bias switch SB 140 in response to the elapse of the threshold duration TTH after the turn ON of the bias switch SB 140.

Prior to time t₅, the bias voltage V_{BIAS} 114 has fallen below the lower reference REF−258. At time t₅, the drive signal DR 134 transitions low and controls the power switch S1 114 OFF. Since the power switch S1 114 is OFF and the bias voltage V_{BIAS} 114 has fallen below the lower reference REF−258, the bias drive signal BDR 148 transitions to a high value and controls the turn ON of bias switch SB 140. When the bias switch SB 140 is conducting, the switch voltage V_{Ds} 118 is substantially the sum of the input voltage V_{IN} 102 and the reflected voltage across the input winding 108 due to the auxiliary winding. e.g. voltage V_{BR} of equation (2) above, or mathematically: V_{DS}=V_{IN}+V_{BR}.

At time t₆, a threshold duration TTH 662 has elapsed after the turn ON of the bias switch SB 140. Further, the threshold duration TTH 662 has elapsed before the bias voltage V_{BIAS} 114 has reached the upper reference REF+. As such, the bias drive signal BDR 148 transitions low and controls the turn OFF of the bias switch SB 140.

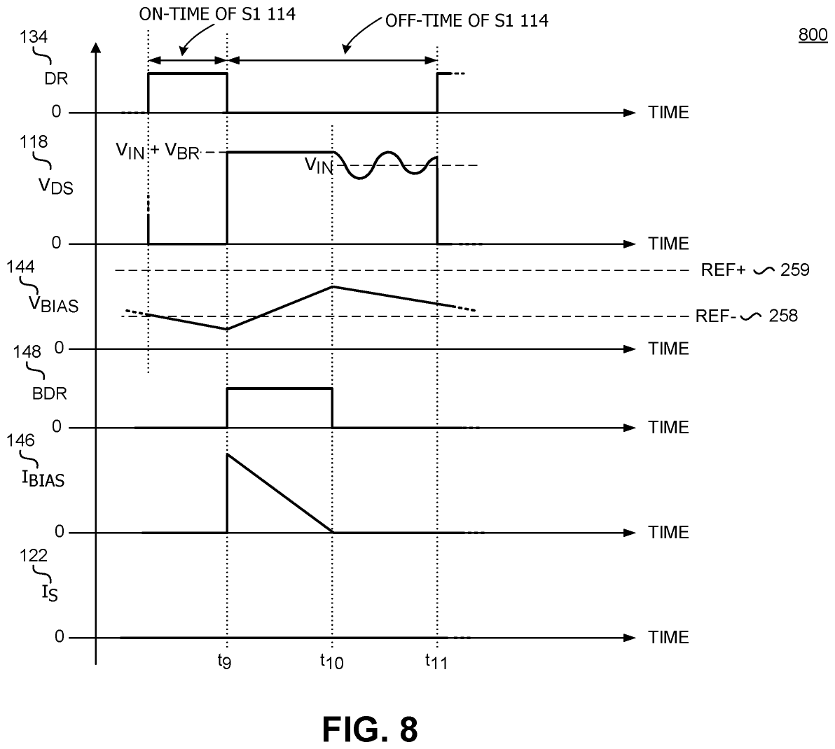

FIG. 8 illustrates timing diagram 800 of example waveforms for the drive signal DR 134, switch voltage V_{Ds} 118 of power switch S1 114, bias voltage V_{BIAS} 144 across bypass capacitor CBP 142, bias drive signal BDR 148, bias current I_{BIAS} 146, and secondary current Iₛ 122. FIG. 8 illustrates controlling the turn ON of the bias switch SB 140 in response to the bias voltage V_{BIAS} 144 falling below the lower reference REF−258 and controlling the turn OFF of the bias switch SB 140 in response to a determination of no stored energy in the energy transfer element T1 106. In one example, the bias current I_{BIAS} 146 reaching zero indicates there is no stored energy in the energy transfer element.

Prior to time to, the bias voltage V_{BIAS} 144 has fallen below the lower reference REF−258. At time to, the drive signal DR 134 transitions low and controls the power switch S1 114 OFF. Since the power switch S1 114 is OFF and the bias voltage V_{BIAS} 114 has fallen below the lower reference REF−258, the bias drive signal BDR 148 transitions to a high value and controls the turn ON of bias switch SB 140. When the bias switch SB 140 is conducting, the switch voltage V_{Ds} 118 is substantially the sum of the input voltage V_{IN} 102 and the reflected voltage across the input winding 108 due to the auxiliary winding, e.g. voltage V_{BR} of equation (2) above, or mathematically: V_{DS}=V_{IN}+V_{BR}.

At time t₁₀, the bias current I_{BIAS} 146 has reached zero. As mentioned above, once the current in the auxiliary winding 112 (e.g. bias current I_{BIAS} 146) or the output winding 110 falls to zero, there is no energy stored in the energy transfer element T1 106. In response to the bias current I_{BIAS} 146 reaching substantially zero, indicating no energy stored in the energy transfer element T1 106, the bias drive signal BDR 148 transitions low and controls the turn OFF of the bias switch SB 140. Relaxation ringing also occurs due to the parasitic inductances and capacitances. For the example shown, no energy is transferred to the output winding 110. In the example shown, the bias switch SB 140 is turned OFF prior to the bias voltage V_{BIAS} 144 reaching the upper reference REF+259.

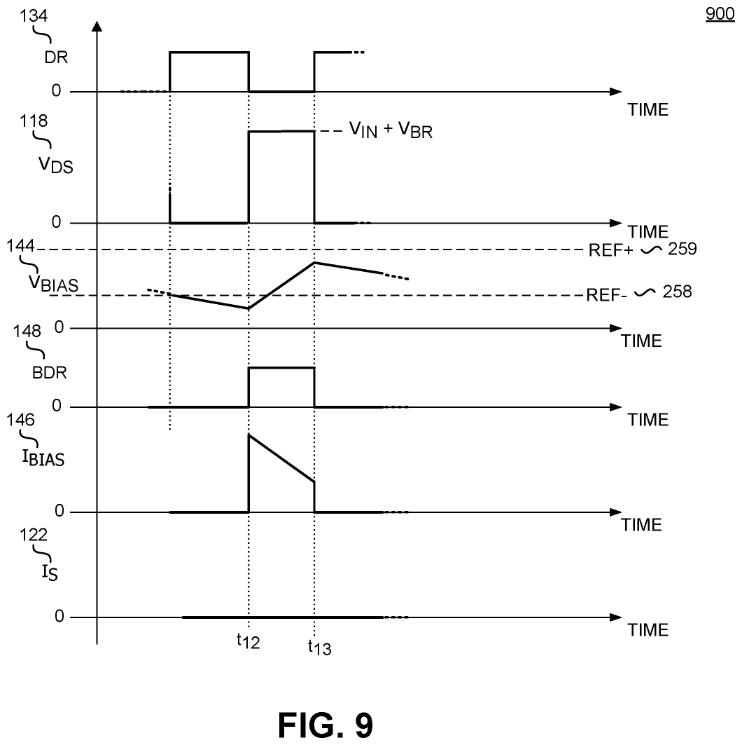

FIG. 9 illustrates timing diagram 900 of example waveforms for the drive signal DR 134, switch voltage V_{Ds} 118 of power switch S1 114, bias voltage V_{BIAS} 144 across bypass capacitor CBP 142, bias drive signal BDR 148, bias current I_{BIAS} 146, and secondary current Iₛ 122. FIG. 9 illustrates controlling the turn ON of the bias switch SB 140 in response to the bias voltage V_{BIAS} 144 falling below the lower reference REF−258 and controlling the turn OFF of the bias switch SB 140 in response to a determination to turn ON the power switch S1 114.

Prior to time t₁₂, the bias voltage V_{BIAS} 144 has fallen below the lower reference REF−258. At time t₁₂, the drive signal DR 134 transitions low and controls the power switch S1 114 OFF. Since the power switch S1 114 is OFF and the bias voltage V_{BIAS} 114 has fallen below the lower reference REF−258, the bias drive signal BDR 148 transitions to a high value and controls the turn ON of bias switch SB 140. While the bias switch SB 140 is conducting, the switch voltage V_{Ds} 118 is substantially the sum of the input voltage V_{IN} 102 and the reflected voltage across the input winding 108 due to the auxiliary winding, e.g. voltage V_{BR} of equation (2) above, or mathematically: V_{DS}=V_{IN}+V_{BR}.

At time t₁₃, the drive signal DR 134 transitions high, indicating that the first controller has determined to turn ON the power switch S1 114. In response to the determination to turn ON the power switch S1 114, the bias drive signal BDR 148 transitions to a low value to control the turn OFF of the bias switch SB 140. In the example shown, the bias switch SB 140 is turned OFF prior to the bias voltage V_{BIAS} 144 reaching the upper reference REF+259. Since the current in the auxiliary winding 112 did not reach zero, there is a non-zero current present for the input winding 108 the next time the power switch S1 114. As such, for the example shown in FIG. 9, the power converter is operating in continuous conduction mode (CCM).

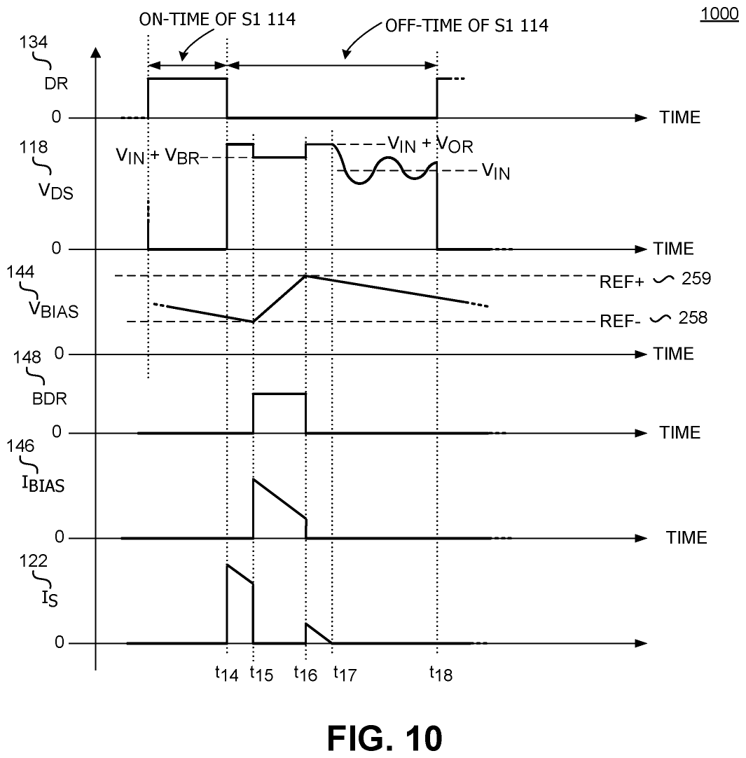

FIG. 10 illustrates timing diagram 1000 of example waveforms for the drive signal DR 134, switch voltage V_{Ds} 118 of power switch S1 114, bias voltage V_{BIAS} 144 across bypass capacitor CBP 142, bias drive signal BDR 148, bias current I_{BIAS} 146, and secondary current Iₛ 122. FIG. 10 illustrates controlling the turn ON of the bias switch SB 140 in response to the bias voltage V_{BIAS} 144 falling below the lower reference REF−258 during the off-time of the power switch S1 114 and controlling the turn OFF of the bias switch SB 140 in response to the bias voltage V_{BIAS} 144 reaching the upper reference REF+259.

At time t₁₄, the drive signal DR 134 transitions to a low value, indicating the turn OFF of power switch S1 114. The bias voltage V_{BIAS} 144 is above the lower reference REF−258 and bias drive signal BDR 148 remains low and controls the bias switch SB 140 OFF. Energy is transferred to output winding 110 and secondary current Iₛ 122 is non-zero. The switch voltage V_{DS} 118 is substantially the sum of the input voltage V_{IN} 102 and the reflected voltage across the input winding 108 due to the output winding 110 as shown in equation (1), or mathematically: V_{DS}=V_{IN}+V_{OR}.

At time t₁₅, the bias voltage V_{BIAS} 144 reaches the lower reference REF−258. The bias drive signal BDR 148 transitions high and controls the turn ON of bias switch SB 140. While the bias switch SB 140 is conducting, the switch voltage V_{Ds} 118 is substantially the sum of the input voltage V_{IN} 102 and the reflected voltage across the input winding 108 due to the auxiliary winding, e.g. voltage V_{BR} of equation (2) above, or mathematically: V_{DS}=V_{IN}+V_{BR}. As shown, the bias current I_{BIAS} 146 is non-zero but the secondary current Iₛ 122 is substantially zero, as the energy is now transferred to the auxiliary winding 112 rather than the output winding 110.

At time t₁₆, the bias voltage V_{BIAS} 144 reaches the upper reference REF+259 and the bias drive signal BDR 148 transitions to a low value to control the turn OFF of the bias switch SB 140. However, the bias switch SB 140 was turned OFF while there is still stored energy in the energy transfer element T1 106. As such, energy is delivered to output winding 110 and secondary current Iₛ 122 is non-zero.

At time t₁₇, secondary current Iₛ 122 reaches zero and there is no stored energy in the energy transfer element T1 106. As such, ringing occurs (also referred to as a relaxation ring) due to the parasitic inductances and capacitances. For the example shown, the relaxation ring oscillates around the input voltage V_{IN} 102. At time t₁₈, the drive signal DR 134 transitions to a high value to control the power switch S1 114 ON.

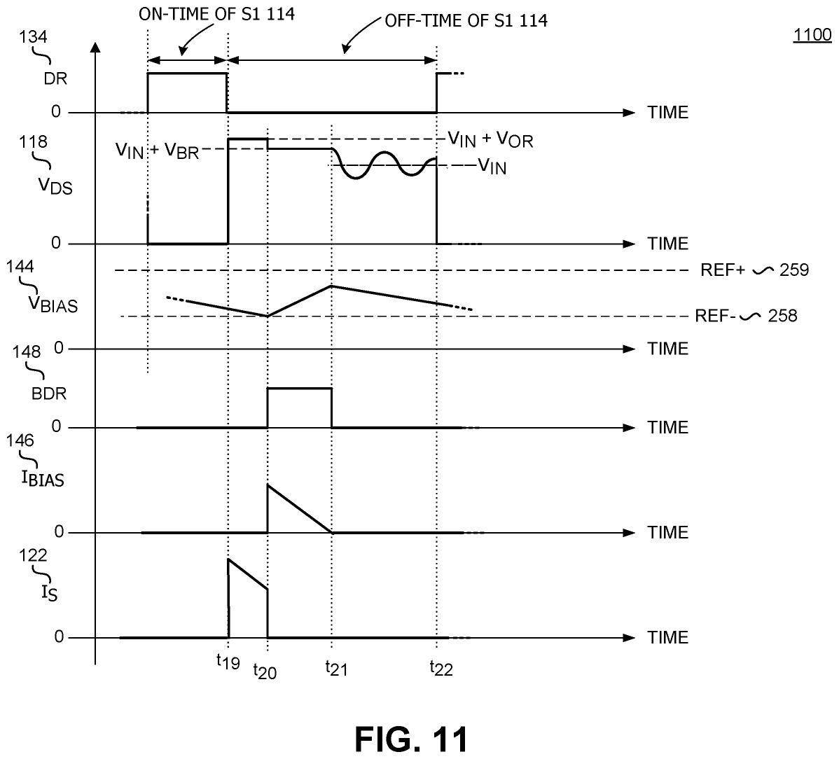

FIG. 11 illustrates timing diagram 1100 of example waveforms for the drive signal DR 134, switch voltage V_{Ds} 118 of power switch S1 114, bias voltage V_{BIAS} 144 across bypass capacitor CBP 142, bias drive signal BDR 148, bias current I_{BIAS} 146, and secondary current Iₛ 122. FIG. 11 illustrates controlling the turn ON of the bias switch SB 140 in response to the bias voltage V_{BIAS} 144 falling below the lower reference REF−258 during the off-time of the power switch S1 114 and controlling the turn OFF of the bias switch SB 140 in response to a determination of no stored energy in the energy transfer element T1 106. In one example, the bias current I_{BIAS} 146 reaching zero indicates there is no stored energy in the energy transfer element T1 106.

At time t₁₉, the drive signal DR 134 transitions to a low value, indicating the turn OFF of power switch S1 114. The bias voltage V_{BIAS} 144 is above the lower reference REF−258 and bias drive signal BDR 148 remains low and controls the bias switch SB 140 OFF. Energy is transferred to output winding 110 and secondary current Iₛ 122 is non-zero. The switch voltage V_{DS} 118 is substantially the sum of the input voltage V_{IN} 102 and the reflected voltage across the input winding 108 due to the output winding 110 as shown in equation (1), or mathematically: V_{DS}=V_{IN}+V_{OR}.

At time t₂₀, the bias voltage V_{BIAS} 144 reaches the lower reference REF−258. The bias drive signal BDR 148 transitions high and controls the turn ON of bias switch SB 140. While the bias switch SB 140 is conducting, the switch voltage V_{Ds} 118 is substantially the sum of the input voltage V_{IN} 102 and the reflected voltage across the input winding 108 due to the auxiliary winding, e.g. voltage V_{BR} of equation (2) above, or mathematically: V_{DS}=V_{IN}+V_{BR}. As shown, the bias current I_{BIAS} 146 is non-zero but the secondary current Iₛ 122 is substantially zero, as the energy is now transferred to the auxiliary winding 112 rather than the output winding 110.

At time t₂₁, the bias current I_{BIAS} 146 has reached zero. As mentioned above, once the current in the auxiliary winding 112 (e.g. bias current I_{BIAS} 146) or the output winding 110 falls to zero, there is no energy stored in the energy transfer element T1 106. In response to the bias current I_{BIAS} 146 reaching substantially zero, indicating no energy stored in the energy transfer element T1 106, the bias drive signal BDR 148 transitions low and controls the turn OFF of the bias switch SB 140. Relaxation ringing also occurs due to the parasitic inductances and capacitances. For the example shown, no energy is transferred to the output winding 110. In the example shown, the bias switch SB 140 is turned OFF prior to the bias voltage V_{BIAS} 144 reaching the upper reference REF+259.

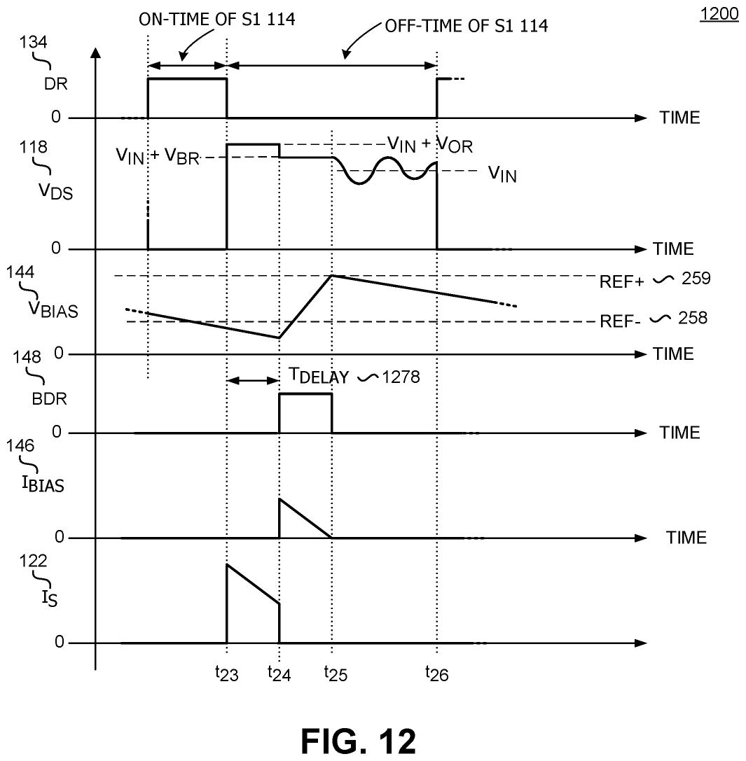

FIG. 12 illustrates timing diagram 1200 of example waveforms for the drive signal DR 134, switch voltage V_{Ds} 118 of power switch S1 114, bias voltage V_{BIAS} 144 across bypass capacitor CBP 142, bias drive signal BDR 148, bias current I_{BIAS} 146, and secondary current Iₛ 122. FIG. 12 illustrates controlling the turn ON of the bias switch SB 140 in response to the bias voltage V_{BIAS} 144 falling below the lower reference REF−258 and controlling the turn OFF of the bias switch SB 140 reaching the upper reference REF+259. Further, FIG. 12 illustrates the bias switch SB 140 is not turned ON until a delay period TDELAY 1278 has elapsed.

Prior to time t₂₃, the bias voltage V_{BIAS} 144 has fallen below the lower reference REF−258. At time t₂₃, the drive signal DR 134 transitions low and controls the power switch S1 114 OFF. Since the power switch S1 114 is OFF and the bias voltage V_{BIAS} 114 has fallen below the lower reference REF−258, the bias switch SB 140 should be controlled ON. However, the bias drive signal BDR 148 transitions to a high value to control the turn ON of bias switch SB 140 after the delay period TDELAY 1278 has elapsed. As such, during the delay period TDELAY 1278, the energy is delivered to the output winding 110 and the secondary current Iₛ 122 is non-zero. The switch voltage V_{DS} 118 is substantially the sum of the input voltage V_{IN} 102 and the reflected voltage across the input winding 108 due to the output winding 110 as shown in equation (1), or mathematically: V_{DS}=V_{IN}+V_{OR}.

At time t₂₄, the delay period TDELAY 1278 has elapsed and the bias drive signal BDR 148 transitions to a high value and controls the turn ON of bias switch SB 140. Energy is transferred to auxiliary winding 112 rather than the output winding 110. The bias current I_{BIAS} 146 is non-zero while the secondary current Iₛ 122 is substantially zero. When the bias switch SB 140 is conducting, the switch voltage V_{DS} 118 is substantially the sum of the input voltage V_{IN} 102 and the reflected voltage across the input winding 108 due to the auxiliary winding, e.g. voltage V_{BR} of equation (2) above, or mathematically: V_{DS}=V_{IN}+V_{BR}.

At time t₁₅, the bias voltage V_{BIAS} 144 has reached upper reference REF+259. Bias drive signal BDR 148 transitions low and controls the turn OFF of the bias switch SB 140. At time t₂₆, the drive signal DR 134 transitions to a high value to control the power switch S1 114 ON.

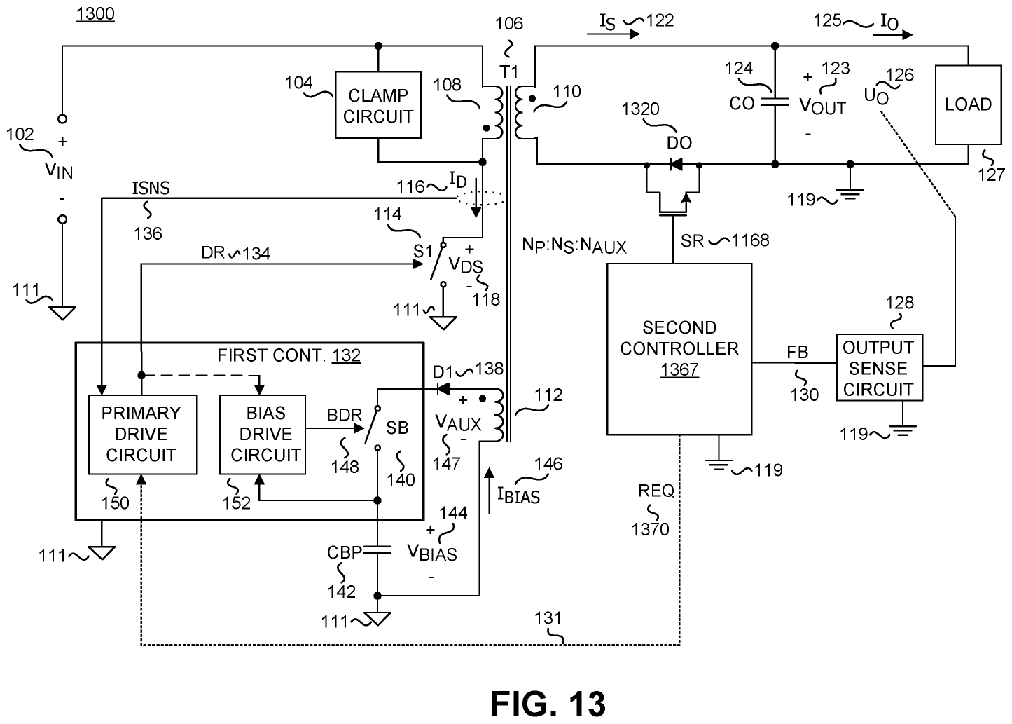

FIG. 13 illustrates a power converter 1300, which is substantially similar to power converter 100 shown in FIG. 1A and power converter 101 shown in FIG. 1B, and similarly named and numbered elements couple and function as described above. At least one difference, however, is the output rectifier DO 1320 is shown as a synchronous rectifier. Further, a second controller 1367 is coupled to receive the feedback signal FB 130 from output sense circuit 128 and communicates a request signal REQ 1170 to the first controller 132. The second controller 1367 is configured to output a secondary drive signal SR 1168 to control the turn ON and turn OFF of the output rectifier DO 1320.

The second controller 1367 is configured to output the request signal REQ 1370 in response to the feedback signal FB 130. In another example, the second controller 1367 is configured to pass along the feedback signal FB 130 to the first controller 132. For the example of a request signal REQ 1370, the request signal REQ 1370 is representative of a request to turn ON the power switch S1 114. The request signal REQ 1370 may include request events which are generated in response to the feedback signal FB 130. In one example operation, the second controller 1367 is configured to compare the feedback signal FB 130 with a regulation reference. In response to the comparison, the second controller 1367 may output a request event in the request signal REQ 1370 to request the first controller 132 to turn ON the power switch S1 114. The request signal REQ 1370 may be a rectangular pulse waveform which pulses to a logic high value and quickly returns to a logic low value. The logic high pulses may be referred to as request events. In other embodiments it is understood that request signal REQ 1370 could be an analog, continually varying signal, rather than a pulsed waveform, while still benefiting from the teachings of the present disclosure.

The second controller 1367 and the first controller 132 may communicate via the communication link 131. For the example shown, the second controller 1367 is coupled to the secondary side of the power converter 100 and is referenced to the output return 119 while the first controller 132 is coupled to the primary side of the power converter 1300 and is referenced to the input return 111. In some embodiments, the first controller 132 and the second controller 1367 are galvanically isolated from one another and communication link 131 provides galvanic isolation using an inductive coupling (such as a transformer or a coupled inductor, an optocoupler), capacitive coupling, or other device that maintains the isolation. However, it should be appreciated that in some embodiments, the second controller 1367 is not galvanically isolated from the first controller 132. In one example, the communication link 131 may be an inductive coupling formed from a leadframe, which supports the first controller 132 and/or the second controller 1367.

In one example, the first controller 132 and second controller 1367 may be formed as part of an integrated circuit that is manufactured as either a hybrid or monolithic integrated circuit. In one example, the power switch S1 114 may also be integrated in a single integrated circuit package with the first controller 132 and the second controller 1367. In addition, in one example, first controller 132 and second controller 1367 may be formed as separate integrated circuit die. The power switch S1 114 or a portion of the power switch S1 114 may also be integrated in the same integrated circuit die as the first controller 132 or could be formed on its own integrated circuit die. Further, it should be appreciated that both the first controller 132, the second controller 1367 and power switch S1 114 need not be included in a single package and may be implemented in separate controller packages or a combination of combined/separate packages.

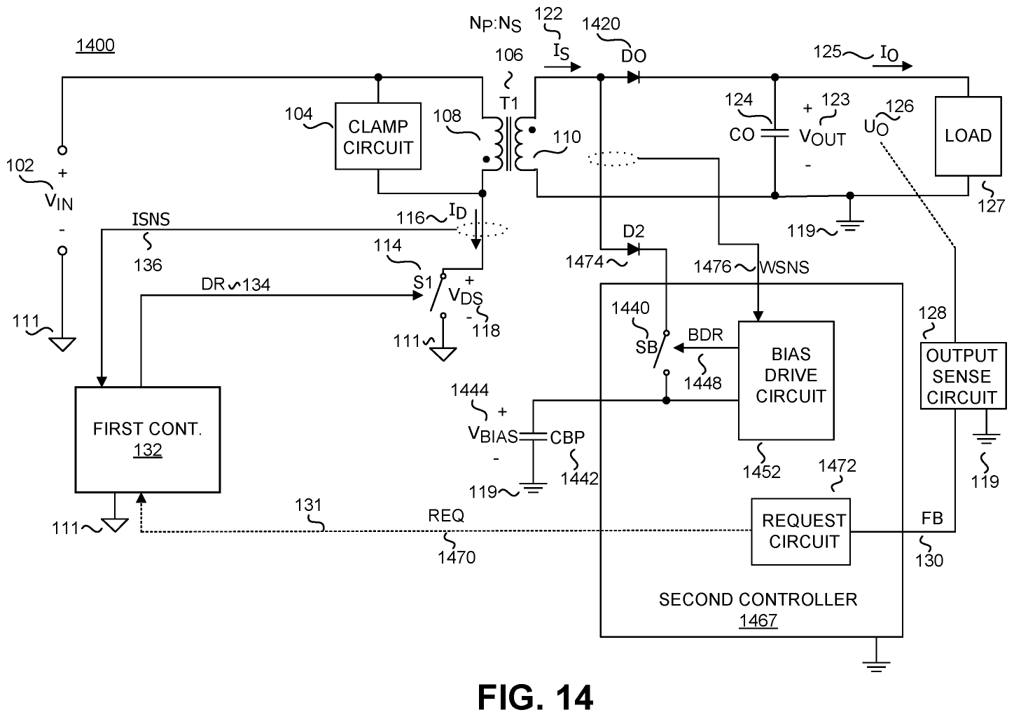

FIG. 14 is a schematic diagram of an example isolated power converter 1400 including a second controller 1467 referenced to an output of the power converter 1400 with a bias drive circuit 1452 to control a bias switch 1440, in accordance with embodiments of the present disclosure. The power converter 1400 of FIG. 14 is substantially similar to power converter 100 shown in FIG. 1A and power converter 101 shown in FIG. 1B, and similarly named and numbered elements couple and function as described above. At least one difference, however, is use of a winding sense signal WSNS 1476 that is representative of the voltage of the output winding 110. The bias drive circuit 1452 utilizes the winding sense signal WSNS 1476 to determine when the power switch S1 114 has turned OFF. In other words, the winding sense signal WSNS 1476 may be utilized as a signal representative of the voltage of the output winding 110.

Output winding 110 is coupled to output rectifier DO 1420, which is exemplified as a diode. Output capacitor CO 124 is shown as being coupled to the output rectifier DO 1420 and output return 119. The output current I_{O} 125 and output voltage V_{OUT} 123 are provided to the load 127. The power converter 1400 further includes circuitry to regulate the output quantity Uo 126, which in one example may be the output voltage V_{OUT} 123, output current I_{O} 125, or a combination of the two. For the example shown, the output sense circuit 128 is configured to sense the output quantity Uo 126 to provide the feedback signal FB 130, representative of the output (e.g. the output quantity U_{O} 126) of the power converter 1400, to the second controller 1467. The second controller 1467 is coupled to receive the feedback signal FB 130 and communicates a request signal REQ 1470 to the first controller 132. The second controller 1467 is configured to output the request signal REQ 1470 in response to the feedback signal FB 130. In one example, the request signal REQ 1470 is representative of a request to turn ON the power switch S1 114. The request signal REQ 1470 may include request events, which are generated in response to the feedback signal FB 130.

The first controller 132 receives the request signal REQ 1470 via a communication link 131, which provides galvanic isolation. The communication link 131 may provide galvanic isolation utilizing an inductive coupling (such as a transformer or a coupled inductor, an optocoupler), capacitive coupling, or other device could be utilized for the communication link 131 and maintain the galvanic isolation. The first controller 132 controls the turn ON and turn OFF of the power switch S1 114 in response to the request signal REQ 1470. In one example, the first controller 132 controls the turn ON and turn OFF of the power switch S1 114 in response to request events in the request signal REQ 1470.

In one embodiment, the first controller 132 outputs the drive signal DR 134 to control the conduction of the power switch S1 114. In particular, the drive signal DR 134 is provided to control the turn ON of the power switch S1 114 in response to the request signal REQ 1470. While the power switch S1 114 is conducting, energy is stored in the energy transfer element T1 106. The first controller 132 may control the turn OFF of the power switch S1 114 in response to the feedback signal FB 130. In another embodiment, the first controller 132 may control the turn OFF of the power switch S1 114 in response to the switch current ID 116 provided by the current sense signal ISNS 136 reaching a current limit. For the power converter 1400 shown in FIG. 14, when the power switch S1 114 is not conducting, energy is transferred to the output winding 110 or to a bypass capacitor CBP 1442 of the second controller 1467.

The second controller 1467 is coupled to receive the feedback signal FB 130 from output sense circuit 128 and a request circuit 1472 in the second controller 1467 communicates a request signal REQ 1470 to the first controller 142 via communication link 131. The request circuit 1472 is configured to output the request signal REQ 1470 in response to the feedback signal FB 130. In one embodiment, the request circuit 1472 compares the feedback signal FB 130 with a regulation reference. In response to the comparison, the request circuit 1472 may output a request event in the request signal REQ 1470 to request the first controller 132 to turn ON the power switch S1 114.

Bias switch SB 1440 is shown as coupled to a bypass capacitor CBP 1442. The second controller 1467 controls the turn ON and OFF of the bias switch SB 1440. Bypass capacitor CBP 1442 is the voltage source for the second controller 1467, which provides bias supply to the internal circuits of the second controller 1467 such that the internal circuits have the appropriate voltage and/or currents to operate. As used herein, the bias switch SB 1440 that is turned ON may conduct current, and can be referred to as being transitioned into a conducting state. Accordingly, the bias switch SB 1440 that is ON can be referred to as being in the conducting state. The bias switch SB 1440 that is turned OFF may not conduct current, and can be referred to as being transitioned into a non-conducting state. Accordingly, the bias switch SB 1440 that is OFF can be referred to as being in the non-conducting state.

When the bias switch SB 1440 is conducting, energy is redirected to the bypass capacitor CBP 1442 instead of to the output rectifier DO 1420. In some aspects, the output rectifier DO 1420 is reversed biased when the bias switch SB 1440 is in the nonconducting state and the output rectifier DO 1420 is forward biased when the bias switch SB 1440 is in the conducting state. The turning ON and OFF of the bias switch SB 1440 regulates the voltage V_{BIAS} 1444 of the bypass capacitor CBP 1442 such that the bypass capacitor CBP 1442 may provide sufficient operating power for the second controller 1467.

The bias drive circuit 1452 receives the bias voltage V_{BIAS} 1444 and the winding sense signal WSNS 1476 and outputs the bias drive signal BDR 1448 to control the turn ON and turn OFF of the bias switch SB 1440. For example, the bias drive circuit 1452 may control operation of the bias switch SB 1440 during at least part of the second portion of the switching cycle to drive a secondary current Iₛ 122 to the bypass capacitor CBP 1442 for providing a bias supply to the second controller 1467. As shown, the secondary current Iₛ 122 is the current flowing through the output winding 110. When the bias switch SB 1440 is in the conducting state, the secondary current Iₛ 122 flows to the bypass capacitor CBP 1442 instead of to diode DO 1420 and the output of the power converter 1400. In some implementations, the bias drive circuit 1452 can cause the bias switch SB 1440 to transition into a conducting state during at least part of the second portion of the switching cycle based on the signal representative of the voltage of the output winding 110. It should be appreciated, however, that other signals may be utilized to represent the voltage of the output winding 110.

The bias drive circuit 1452 controls the turn ON and OFF of the bias switch SB 1440 to regulate the bias voltage V_{BIAS} 1444 across the bypass capacitor CBP 1442. For example, the bias drive circuit 1452 can control operation of the output rectifier DO 1420 coupled between the output winding 110 and the output capacitor CO 124 and/or a diode D2 1474 coupled between the output winding 110 and the bias switch SB 1440 during at least part of the second portion of the switching cycle with the bias switch SB 140 in the conducting state and substantially no current is conducted through the bypass capacitor CBP 1442 during the first portion of the switching cycle with the bias switch SB 140 in the nonconducting state. In some embodiments, the bias drive circuit 1452 turns ON the bias switch SB 1440 such that the secondary current Iₛ 122 flows through the diode D2 1474 rather than to the output rectifier DO 1420. In some implementations, the bias switch SB 1440 in the nonconducting state allows the secondary current Iₛ 122 to flow to the output rectifier DO 1420.

The above description of illustrated examples of the present disclosure, including what is described in the Abstract, are not intended to be exhaustive or to be limitation to the precise forms disclosed. While specific embodiments of, and examples for, the disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A controller for use in a power converter having an energy transfer element, the controller comprising:
a primary drive circuit configured to control operation of a primary switch coupled to a primary winding associated with the energy transfer element, the primary drive circuit causing the primary switch to transition between a conducting state during a first portion of a switching cycle and a nonconducting state during a second portion of the switching cycle; and
a bias drive circuit configured to control operation of a bias switch coupled to an auxiliary winding associated with the energy transfer element to drive a bias current to a bypass capacitor coupled to the bias drive circuit for providing a bias supply to the controller.

2. The controller of claim 1, wherein the bias drive circuit is further configured to control the operation of the bias switch during at least part of the first portion of the switching cycle.

3. The controller of claim 1, wherein the bias drive circuit is further configured to cause the bias switch to transition between a conducting state and a nonconducting state based on a bias voltage across the bypass capacitor.

4. The controller of claim 1, wherein the bias drive circuit is further configured to control the operation of the bias switch during at least part of the second portion of the switching cycle.

5. The controller of claim 4, wherein the bias drive circuit is further configured to cause conduction of a bias current in the auxiliary winding during the at least part of the second portion of the switching cycle with the bias switch in the conducting state and substantially no current is conducted in the auxiliary winding during the first portion of the switching cycle with the bias switch in the nonconducting state.

6. The controller of claim 1, wherein the bias drive circuit is further configured to cause the bias switch to transition into a conducting state during based on a comparison between a bias voltage across the bypass capacitor and a reference.

7. The controller of claim 1, wherein the bias drive circuit is further configured to cause the bias switch to transition into a conducting state during at least part of the second portion of the switching cycle based on a signal representative of the nonconducting state of the primary switch from the primary drive circuit.

8. The controller of claim 1, wherein the bias drive circuit is further configured to drive a bias drive signal to the bias switch to cause the bias switch to transition between a conducting state and a nonconducting state based on a bias voltage across the bypass capacitor, wherein the bias switch in the conducting state causes a bias current through the auxiliary winding instead of through a secondary winding associated with the energy transfer element, and wherein the bias switch in the nonconducting state allows a secondary current to flow through the secondary winding.

9. The controller of claim 8, wherein the bias drive circuit is further configured to:
compare the bias voltage to a first reference and a second reference greater than the first reference,
drive the bias drive signal to a first value that causes the bias switch to transition into the conducting state when the bias voltage is lower than the first reference, the bias drive signal being driven to the first value for a duration during which the bias voltage is increased towards the second reference, and
drive the bias drive signal to a second value smaller than the first value that causes the bias switch to transition into the nonconducting state when the bias voltage reaches the second reference.

10. The controller of claim 8, wherein the bias drive circuit is further configured to cause the bias switch to transition into the conducting state during at least part of the second portion of the switching cycle based on a duration threshold corresponding to the at least part of the second portion of the switching cycle.

11. The controller of claim 10, wherein the bias drive circuit is further configured to:
compare the bias voltage to a first reference and a second reference greater than the first reference,
drive the bias drive signal to a first value that causes the bias switch to transition into the conducting state when the bias voltage is lower than the first reference, the bias drive signal being driven to the first value for a duration during which the bias voltage is increased towards the second reference and the duration does not exceed the duration threshold, and
drive the bias drive signal to a second value smaller than the first value that causes the bias switch to transition into the nonconducting state when the bias voltage reaches the second reference, a signal representative of the conducting state of the primary switch from the primary drive circuit indicates that the primary switch is in the conducting state or the duration exceeds the duration threshold.

12. The controller of claim 8, wherein the bias drive circuit is further configured to cause the bias switch to transition into the nonconducting state during at least part of the second portion of the switching cycle based on the bias current flowing through the auxiliary winding.

13. The controller of claim 12, wherein the bias drive circuit is further configured to:
compare the bias voltage to a first reference and a second reference greater than the first reference,
drive the bias drive signal to a first value that causes the bias switch to transition into the conducting state when the bias voltage is lower than the first reference, the bias drive signal being driven to the first value for a duration during which the bias voltage is increased towards the second reference and the bias current has not reached zero current, and
drive the bias drive signal to a second value smaller than the first value that causes the bias switch to transition into the nonconducting state when the bias voltage reaches the second reference, a signal representative of the conducting state of the primary switch from the primary drive circuit indicates that the primary switch is in the conducting state or the bias current has reached zero current.

14. The controller of claim 12, wherein the bias drive circuit is further configured to sense the bias current flowing through the auxiliary winding based on an auxiliary voltage across the auxiliary winding, wherein the bias drive circuit is further configured to cause the bias switch to transition into the nonconducting state based on the auxiliary voltage.

15. The controller of claim 8, wherein a first ratio of an auxiliary voltage across the auxiliary winding to a number of turns in the auxiliary winding is lesser than or equal to a second ratio of an output voltage across the secondary winding of the energy transfer element to a number of turns in the secondary winding.

16. The controller of claim 1, wherein the bias drive circuit is further configured to cause the bias switch to transition into a conducting state during at least part of the second portion of the switching cycle based on a delayed version of a signal representative of the non-conducting state of the primary switch from the primary drive circuit.

17. The controller of claim 1, wherein the controller comprises the bias switch.

18. A controller for use in a power converter having an energy transfer element, the controller comprising:
a primary drive circuit configured to control operation of a primary switch coupled to a primary winding associated with the energy transfer element, the primary drive circuit causing the primary switch to transition between a conducting state during a first portion of a switching cycle and a nonconducting state during a second portion of the switching cycle;
a bias switch coupled to a bypass capacitor; and
a bias drive circuit configured to control operation of the bias switch to drive a bias current to a bypass capacitor coupled to the bias switch for providing a bias supply to the controller.

19. A power converter for providing power to a load, the power converter comprising:
an energy transfer element comprising a primary winding and a secondary winding, the primary winding being coupled to an input voltage during a first portion of a switching cycle and configured to generate a secondary current through the secondary winding during a second portion of the switching cycle;
an output capacitor coupled to the secondary winding; and
a controller configured to control transfer of energy between the primary winding and the secondary winding, the controller comprising a bias drive circuit configured to control conduction of a bias current through a bias switch instead of through the output capacitor during at least part of the second portion of the switching cycle for providing a bias supply to the controller for the power converter.

20. The power converter of claim 19, wherein the bias drive circuit is further configured to control operation of the bias switch during the at least part of the second portion of the switching cycle to drive the bias current to a bypass capacitor coupled to the bias switch.

21. The power converter of claim 20, wherein the bias drive circuit is further configured to control operation of the bias switch to drive the bias current to the bypass capacitor during the at least part of the second portion of the switching cycle by causing the bias switch to transition between a conducting state and a nonconducting state based on a bias voltage across the bypass capacitor.

22. The power converter of claim 21, wherein the bias switch is coupled to an auxiliary winding having a same input return as the primary winding.

23. The power converter of claim 21, wherein the bias switch is coupled to the secondary winding.

24. The power converter of claim 21, wherein the controller further comprises:
a first controller associated with the primary winding; and
a second controller associated with the secondary winding, the second controller having the bias drive circuit and the bias switch, wherein the first controller and the second controller are configured to communicate via a communication link between the first controller and the second controller.

25. The power converter of claim 24, further comprising an output rectifier coupled between the secondary winding and the output capacitor.

26. The power converter of claim 25, wherein the output rectifier is reversed biased when the bias switch is in the nonconducting state and is forward biased when the bias switch is in the conducting state.

27. The power converter of claim 25, wherein the bias drive circuit is further configured to drive a bias drive signal to the bias switch to cause the bias switch to transition between the conducting state and the nonconducting state based on the bias voltage across the bypass capacitor and a signal representative of a voltage across the secondary winding, wherein the bias switch in the conducting state redirects current to the bypass capacitor instead of to the output rectifier, and wherein the bias switch in the nonconducting state allows the current to flow to the output rectifier.

28. The power converter of claim 19, wherein the bias drive circuit is further configured to control operation of the bias switch during at least part of the first portion of the switching cycle.
